(19) United States
(12) Patent Application Publication
(10) Pub. No.: US 2026/0141424 A1
(43) Pub. Date: May 21, 2026

(54) METHODS AND SYSTEMS OF FACILITATING DYNAMIC AND FRACTIONAL ADVERTISEMENT SCHEDULING

(71) Applicant: Yunior Savon, Hialeah, FL (US)

(72) Inventor: Yunior Savon, Hialeah, FL (US)

(21) Appl. No.: 19/309,337

(22) Filed: Aug. 25, 2025

Related U.S. Application Data
(60) Provisional application No. 63/722,990, filed on Nov. 20, 2024.

(51) Int. Cl. G06Q 30/0251

(52) U.S. Cl. CPC G06Q 30/0264

(57) ABSTRACT

The present disclosure provides a method of facilitating dynamic and fractional advertisement scheduling. Further, the method includes obtaining operational period data of presentation devices, analyzing the operational period data, segmenting operation periods into time segments based on the analyzing of the operational period data, receiving an advertisement data from a user device, receiving a preference data from the user device, analyzing the preference data, identifying preferred time segments from the time segments based on the analyzing of the preference data, assigning the advertisement data to the preferred time segments, generating schedules for the presentation devices based on the assigning, and executing the schedules based on the schedules.

### FIELD OF DISCLOSURE

The present disclosure generally relates to the field of data processing. More specifically, the present disclosure relates to methods and systems of facilitating dynamic and fractional advertisement scheduling.

### BACKGROUND

Digital Out-of-Home Advertising (DOOH) has become an increasingly important medium for businesses seeking to engage consumers in public spaces. DOOH advertising allows advertisers to display their messages on screens located at high-traffic areas such as billboards, transit shelters, and digital screens. While DOOH offers a unique opportunity to reach a broad audience, there are challenges that limit its accessibility and effectiveness.

One of the primary challenges in DOOH is the cost associated with securing premium ad slots. Many small businesses and individuals find it difficult to compete with larger advertisers due to the high expense of traditional ad spaces. This limitation reduces the ability of smaller entities to effectively reach their target audience, limiting their visibility in a crowded marketplace.

Current DOOH advertising systems face several challenges that hinder their effectiveness and impact. Existing systems often allocate large advertising slots inflexibly, leading to underutilization of inventory and wasted opportunities for advertisers. These systems frequently rely on fixed schedules, which fail to adapt quickly to changing market demands or real-time data. The review and approval of ad content are often slow, risking the presence of non-compliant or harmful content that violates brand safety guidelines. Advertisers may struggle to gain priority for their ads without compensating displaced parties, leading to inequitable distribution of slots. Media owners often lack comprehensive tools to manage their inventory effectively, monitor performance, or integrate scheduling with other platforms. Current systems may not provide timely insights into ad performance or inventory usage, hindering informed decision-making.

Therefore, there is a need for improved methods and systems of facilitating dynamic and fractional advertisement scheduling, that can overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating dynamic and fractional advertisement scheduling. Further, the method may include obtaining, using a processing device, one or more operational period data of one or more presentation devices. Further, the one or more operational period data represents one or more operational periods of the one or more presentation devices. Further, the method may include analyzing, using the processing device, the one or more operational period data. Further, the method may include segmenting, using the processing device, the one or more operational periods into two or more time segments based on the analyzing of the one or more operational period data. Further, the method may include receiving, using the communication device, an advertisement data from a user device associated with a user. Further, the advertisement data includes one or more contents to be presented on the one or more presentation devices. Further, the method may include receiving, using the communication device, a preference data from the user device. Further, the preference data indicates a user preference for presenting the one or more contents on the one or more presentation devices. Further, the method may include analyzing, using the processing device, the preference data. Further, the method may include identifying, using the processing device, one or more preferred time segments from the two or more time segments for the presenting of the one or more contents based on the analyzing of the preference data. Further, the method may include assigning, using the processing device, the advertisement data to the one or more preferred time segments based on the identifying of the one or more preferred time segments. Further, the method may include generating, using the processing device, one or more schedules for the one or more presentation devices based on the assigning. Further, the method may include executing, using the processing device, the one or more schedules based on the one or more schedules. Further, the executing of the one or more schedules includes presenting the one or more contents during the one or more preferred time segments.

The present disclosure provides a system for facilitating dynamic and fractional advertisement scheduling. Further, the system may include a processing device. Further, the processing device may be configured for obtaining one or more operational period data of one or more presentation devices. Further, the one or more operational period data represents one or more operational periods of the one or more presentation devices. Further, the processing device may be configured for analyzing the one or more operational period data. Further, the processing device may be configured for segmenting the one or more operational periods into two or more time segments based on the analyzing of the one or more operational period data. Further, the processing device may be configured for analyzing a preference data. Further, the processing device may be configured for identifying one or more preferred time segments from the two or more time segments for presenting one or more contents based on the analyzing of the preference data. Further, the processing device may be configured for assigning an advertisement data to the one or more preferred time segments based on the identifying of the one or more preferred time segments. Further, the processing device may be configured for generating one or more schedules for the one or more presentation devices based on the assigning. Further, the processing device may be configured for executing the one or more schedules based on the one or more schedules. Further, the executing of the one or more schedules includes presenting the one or more contents during the one or more preferred time segments. Further, the system may include a communication device communicatively coupled with the processing device. Further, the communication device may be configured for receiving the advertisement data from a user device associated with a user. Further, the advertisement data includes the one or more contents to be presented on the one or more presentation devices. Further, the communication device may be configured for receiving the preference data from the user device. Further, the preference data indicates a user preference for the presenting of the one or more contents on the one or more presentation devices.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating dynamic and fractional advertisement scheduling, in accordance with some embodiments.

FIG. 3B illustrates a continuation of the flowchart of the method 300 of facilitating dynamic and fractional advertisement scheduling, in accordance with some embodiments.

FIG. 4 illustrates a flowchart of a method 400 of facilitating dynamic and fractional advertisement scheduling including determining, using the processing device 802, an infringement of at least one of the brand safety guideline and the regulatory guideline by the at least one content, in accordance with some embodiments.

FIG. 5 illustrates a flowchart of a method 500 of facilitating dynamic and fractional advertisement scheduling including performing, using the processing device 802, at least one operation using at least one emergency override module, in accordance with some embodiments.

FIG. 6 illustrates a flowchart of a method 600 of facilitating dynamic and fractional advertisement scheduling including enabling, using the processing device 802, the at least one technical functionality to the user, in accordance with some embodiments.

FIG. 7 illustrates a flowchart of a method 700 of facilitating dynamic and fractional advertisement scheduling including processing, using the processing device 802, a compensation transaction, in accordance with some embodiments.

FIG. 8 illustrates a block diagram of a system 800 of facilitating dynamic and fractional advertisement scheduling, in accordance with some embodiments.

FIG. 9 illustrates a flowchart of a method 900 of facilitating dynamic and fractional advertisement scheduling including processing, using the processing device 802, a transaction using the at least one payment credential, in accordance with some embodiments.

FIG. 10 illustrates a flowchart of a method 1000 of facilitating dynamic and fractional advertisement scheduling including processing, using the processing device 802, a purchase transaction to purchase the at least one operational period, in accordance with some embodiments.

FIG. 11 illustrates a flowchart of a method 1100 of facilitating dynamic and fractional advertisement scheduling including generating, using the processing device 802, at least one notification data, in accordance with some embodiments.

FIG. 12 illustrates a flowchart of a method 1200 of facilitating dynamic and fractional advertisement scheduling including generating, using the processing device 802, at least one analytic data, in accordance with some embodiments.

FIG. 13 illustrates a flowchart of a method 1300 of facilitating dynamic and fractional advertisement scheduling including generating, using the processing device 802, at least one log data, in accordance with some embodiments.

FIG. 14 illustrates a flowchart of a method 1400 of facilitating dynamic and fractional advertisement scheduling including obtaining, using the processing device 802, at least one filtered content, in accordance with some embodiments.

FIG. 15 illustrates a flowchart of a method 1500 of facilitating dynamic and fractional advertisement scheduling including assigning, using the processing device 802, the plurality of contents to the plurality of preferred time segments, in accordance with some embodiments.

FIG. 16 illustrates a flowchart of a method 1600 of facilitating dynamic and fractional advertisement scheduling including determining, using the processing device 802, at least one of an acceptance of the at least one schedule by the third user and a rejection of the at least one schedule by the third user, in accordance with some embodiments.

FIG. 17 illustrates a flowchart of a method 1700 of facilitating dynamic and fractional advertisement scheduling, in accordance with some embodiments.

FIG. 18 illustrates a flowchart of a process of facilitating dynamic and fractional advertisement scheduling, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes a cloud-based (SaaS) digital out-of-home (DOOH) advertising platform that enables fractional, dynamic, and personalized ad scheduling on shared screens. The system purchases large ad inventory (e.g., hours on premium billboards or screen networks) and algorithmically subdivides this large ad inventory into smaller fractional time segments. These segments are sold to multiple advertisers (businesses and individuals) via two distinct portal workflows: a B2B interface for commercial campaigns and a B2C interface for personal/gift messages. An AI-driven moderation engine automatically reviews all submitted creative (text, images, video) for compliance with brand safety, copyright, COPPA, GDPR and other standards, flagging ambiguous cases for human review. The platform includes a “surge” feature allowing advertisers to pay a premium to expedite their ads; the system then dynamically reschedules existing fractional ads to accommodate the priority ad and credits affected advertisers from the surge fee. An emergency-override module allows designated screens to instantly display public alerts. A centralized control hub provides media owners with inventory management, API integrations, scheduling and performance reporting. The architecture is implemented as distributed, multi-cloud microservices with an event-driven scheduling pipeline, enabling scalability and startup-friendly deployment. Every scheduling change and moderation decision is logged to ensure regulatory compliance and traceability. The disclosed system differs from prior DOOH systems by its real-time fractional allocation, dual UI workflows, integrated AI moderation, and compensatory surge mechanism, offering unprecedented accessibility of premium DOOH space to small advertisers while ensuring transparency and compliance.

Traditional DOOH advertising systems have historically required large, fixed-duration commitments, limiting small advertisers. Some platforms allow purchase of very short digital ad spots (e.g., individual eight-second clips on a billboard) with no long-term contracts. Similarly, some platforms offer daily billboard spots and greeting-card messages at low per-day rates (new advertisers may spend on the order of $19 per day). These models improved accessibility for small businesses, but operate on rigid, pre-packaged time blocks. Further some platforms targets individuals and influencers, selling packages of ten 8-second billboard plays in a 15-minute window for $ 40. In all of these cases, ad inventory is sold as fixed slots with no dynamic subdivision of larger blocks. There remains a need to make high-value DOOH inventory accessible to many small advertisers simultaneously by algorithmically splitting and allocating time.

Existing DOOH management tools focus on scheduling but not fractional sharing. For example, some systems provide an automated scheduling CMS for media owners: once screens and campaign parameters are entered, the system organizes schedules “automatically... at the click of a button”. Alternatively, some management tools offer a cloud CMS to distribute content across multiple displays remotely and provide an API to automate content scheduling and push updates across screens. These solutions streamline campaign management and inventory monitoring, but are designed for dedicated campaigns rather than many small, dynamic inserts into shared inventory.

User-generated content (UGC) on DOOH presents compliance challenges. Industry guidance emphasizes that effective moderation is essential so that displayed content aligns with brand values and legal standards. AI tools can “simplify content categorization and real-time moderation,” enabling safe, compliant handling of large volumes of UGC. Privacy laws require that user data (especially from children) be handled with care. In practice, platforms have demonstrated DOOH with integrated moderation: in one campaign, tens of thousands of consumer-submitted photos were vetted and only “approved photos were displayed on a Times Square billboard”. These examples show that real-time screening for profanity, copyrighted material, adult/violent content, or unauthorized personal data is necessary for DOOH systems that accept user input.

Dynamic pricing models (surge pricing) are known in other industries. For instance, ride-sharing apps adjust fares in real time to balance supply and demand. However, such surge models simply raise prices; they do not reallocate already-scheduled inventory or compensate displaced participants. No DOOH advertising system to date applies a surge-like surcharge to prioritize an ad slot and systematically reassigns existing ads to accommodate the premium placement.

Emergency-alert override is known in digital signage. For example, some applications can “override normal content to display emergency alerts on digital signage displays” in real time. Some applications provide software that “transforms” signage displays into alerting devices where “emergency alerts scroll across digital signage” when activated. While the disclosed systems show that DOOH displays can be commandeered for urgent messages, a unified DOOH advertising platform would require a built-in mechanism to accept government/public alerts and preempt scheduled ads across multiple screens.

Although elements of the disclosed system exist separately (e.g., short-spot ad sales, cloud signage CMS, UGC moderation, and alert overrides), there is no known integrated system that dynamically fractionalizes premium DOOH inventory and sells it via dual portals (business vs consumer), with AI moderation, surge reprioritization with compensation, emergency override, and full audit logging, all in a scalable SaaS architecture. The disclosed system addresses these gaps.

### Key Features of the Disclosed System Include:

1. Fractional Advertising Engine: The system acquires large DOOH media slots from owners or aggregators and algorithmically divides each slot into multiple smaller time segments. These fractional units are dynamically allocated to advertisers based on demand, optimizing utilization of premium screens (unlike existing solutions that require fixed slot purchases). The scheduling algorithm continuously adjusts segment assignments in real time as new ad orders arrive.
2. Dual Workflow Interfaces: Two distinct user portals are provided. The B2B portal is tailored for business advertisers and agencies, offering campaign creation, targeting parameters, budgeting, analytics, and scheduling of multiple ads across screens. The B2C portal is for individuals (personal advertisers) to create simple messages or greeting-card ads (similar to billboard “FlipCards”), select boards and time, and pay, all with a streamlined UX. This separation ensures that each user type has features suited to its needs.
3. AI-Based Moderation Engine: Every ad submission (text, image, video) is subject to automated content analysis. Machine-learning classifiers screen for inappropriate or infringing content (e.g., profanity, hate symbols, copyrighted imagery, personal data of minors) and for compliance with brand safety and legal requirements (GDPR, COPPA, etc.). Suspicious or borderline content is escalated to human reviewers. All moderation outcomes (approved, rejected, escalated) are logged.
4. Dynamic Prioritization (Surge) Module: Advertisers can opt to pay a higher fee (“surge surcharge”) for expedited placement. When a priority request is accepted, the system temporarily reorders the schedule: it finds existing fractional ads that must be displaced (based on timing and demand), removes them, and schedules the priority ad in their stead. The premium collected is partially used to compensate the displaced advertisers (e.g., by issuing account credits or free future runs). This ensures fairness and preserves trust, distinguishing it from conventional surge models which only raise prices without compensating others.
5. Emergency-Override Module: Designated screens can instantly switch from normal advertising to public safety content. Upon receiving an emergency alert signal (e.g., AMBER alert, weather warning), the override module halts scheduled ads and displays the alert message (and any associated media) on all configured DOOH devices. This feature ensures critical information can be broadcast in real-time, leveraging the signage network.
6. Central Scheduling & Reporting Hub: A cloud-based control panel enables media owners to manage their screen inventory, set availability windows, and integrate scheduling via APIs. Owners can onboard new screens, configure time slots, and monitor which ads are scheduled. Analytics dashboards report delivery stats, audience estimates, and system performance.
7. Scalable Distributed Architecture: The platform is implemented as a distributed system of micro services across multiple cloud environments. An event-driven pipeline handles scheduling events (e.g., new ad orders, cancellations, surge requests), ensuring timely updates across the system. Secure APIs connect modules (inventory, scheduling, portals, moderation, alerts). This modular design allows the platform to start lean and scale with customer growth.
8. Compliance Logging: Every action is recorded in an immutable audit log. This includes all scheduling changes (who bought what fraction of which slot and when), all moderation decisions (with timestamps and reviewer IDs for escalations), and all surge-payment and compensation transactions. The comprehensive logging ensures full transparency and allows post-hoc auditing for regulatory and business purposes.

The disclosed system comprises several coordinated modules. An Inventory Module interfaces with DOOH media owners and supply-side platforms. This module ingests information about available large ad slots (e.g. a purchased hour on a Times Square billboard or a digital menu board network). The platform's broker or the owners themselves may “list” block inventory in the system.

Upon acquiring inventory, a Fractional Scheduling Engine algorithmically subdivides each large slot into smaller time segments (fractions). For example, a 60-minute block may be split into 120 half-minute slots or any granularity needed. The engine employs real-time optimization to decide how many fractions and of what duration to allocate, based on current demand. It can also adjust allocations dynamically; if an advertiser cancels, that time can be recombined or reallocated to others. The engine maintains a schedule database that tracks which fractions have been sold for which times. (In some embodiments, the engine uses an event-driven pipeline: scheduling events such as “new order,” “cancellation,” or “surge insertion” generate messages that propagate through the system to update the queue.)

The system provides two distinct user portals. The Business Portal (B2B) is a web interface tailored for commercial advertisers and agencies. It offers functionality typical of ad platforms: users can create campaigns, select targets (by geography, time of day, demographics), upload creative, and set budgets and schedules. Multiple fractional slots across various boards or screens can be reserved, and analytics (impressions served, estimated reach) are shown. The Personal Portal (B2C) is a simplified interface for individuals posting personal messages (birthdays, proposals, greetings, small businesses, influencers). It presents themed templates or a free-form design canvas for the message, a map of available boards, and date/time pickers. Checkout is streamlined (e.g. credit card). The two portals connect to the same back-end scheduling system but enforce different rules: for instance, the B2C portal may require purchase at least one day in advance (to allow for moderation), whereas the B2B portal may allow more flexible lead time and multi-unit orders.

When any user submits an advertisement (text, image, or video), the Content Moderation Engine automatically processes the submission. This engine uses machine-learning models trained for text sentiment, image analysis, and video scanning. It checks against brand safety criteria (filtering hate speech, adult content, violence, drug references, etc.), copyright (detecting unlicensed logos or media), and privacy laws. For example, if a submitted video contains a child's face, COPPA-related rules might trigger a flag. The engine references updated blacklists and legal guidelines. If the automated confidence is low or a violation is detected, the ad is escalated to a human moderator (either in-house or third-party). The moderator reviews the content and decides to approve, reject, or request an edit. All decisions (auto and manual) are logged with timestamps and user IDs. This ensures compliance with GDPR (personal data), COPPA (children), and other regulations. In practice, this step is critical for UGC: as in a prior DOOH campaign, over 60,000 user photos were moderated and only approved images were displayed on Times Square. In our system, the moderation engine similarly filters out disallowed material before any ad is scheduled or played.

Approved ads proceed to scheduling. The Fractional Scheduling Engine assigns each ad to one or more fractional slots based on the requested time, location, and targeting. If an ad exceeds the size of an available fraction, adjacent segments may be grouped. The engine also ensures fair distribution: if many advertisers request the same high-demand slot, the system may allocate shorter periods to each or use a first-come basis. For each scheduled ad, the platform records a reservation entry in the schedule database. Advertisers can view or modify their scheduled ads up to a cutoff time.

A key innovation is the Priority (Surge) Module. An advertiser viewing the schedule can optionally select “priority placement.” This signals that they are willing to pay extra to have their ad shown more immediately. The module computes a surcharge, potentially using a formula that reflects current demand. When a priority request is confirmed, the module triggers a rescheduling operation: it identifies existing scheduled ads whose slots overlap with the desired placement. The system then displaces those ads (removing or shifting them) to free the required time. Displacement is done algorithmically, perhaps by pushing ads to the next available gap or reducing their frequency. Importantly, the module tracks which advertisers were bumped and issues compensation credits to them; these credits come out of the surge premium. For example, if an advertiser paid $100 for priority and displaced two other ads, the system might credit $30 back to each of the displaced parties. This compensatory approach diverges from traditional surge models as some platforms simply surcharge without refunds. All surge transactions (who paid, which ads were moved, what credits were issued) are logged in the system. After adjustment, the schedule is updated and the priority ad is placed into the freed fractional segment(s). If the priority ad does not fit exactly, additional reallocation may occur to accommodate it. In the user interface, both the priority bidder and the bumped advertisers receive notifications of the change and compensation.

The Emergency Override Module continuously monitors for public safety triggers. This can be an API receiving alerts (e.g., from government emergency systems, weather APIs, or a manual operator). When activated, the module immediately interrupts the normal schedule on a predefined set of screens. It pushes emergency content (a text alert, video, or pre-loaded graphic) to those displays, overriding whatever ad was scheduled. After the emergency period ends (as configured), normal scheduling resumes. This capability mirrors known solutions that preempt signage for alerts.

Throughout all operations, a Central Control and Reporting Hub presents information to media owners and administrators. Owners can log into a dashboard to list their screen inventory, configure screen availability/time slots for the broker to purchase, and integrate with the platform via APIs. They can see what content is scheduled on each screen, approve or reject content before it goes live if desired, and view logs of what ads ran. Performance analytics (e.g., total ad impressions, estimated audience counts, revenue earned) are generated from the recorded schedule data. Owners can also pull reports for regulatory compliance.

The entire system is built on a scalable microservices architecture. Each functional component (inventory ingestion, scheduling engine, moderation engine, user portals, surge module, emergency handler) runs as an independent service container. Components communicate via secure REST or message-based APIs. The scheduling pipeline is event-driven: for example, when a new ad order is received, a scheduling event is published and consumed by the allocator. This design allows horizontal scaling: as campaign volume grows, more instances of scheduling or moderation services can be deployed. The system runs in multiple clouds or data centers to ensure reliability. Secure data stores hold the schedule, user data, and logs; encryption and access controls protect user privacy (in line with GDPR).

Finally, Compliance Logging is emphasized. Every decision and action is automatically recorded in an append-only log. This includes each moderation verdict (with reference to rules applied), each fractional slot assignment or change, every surge payment and compensation, and any emergency override event. These logs form an auditable trail for brand and regulatory compliance. In case of disputes (e.g., an advertiser questions whether they were properly charged or if an inappropriate ad slipped through), the logs provide evidentiary detail.

In operation, a user (advertiser) experience might unfold as follows: A user logs into the appropriate portal, selects target screens and dates (browsing a real-time map of availability). They design or upload their ad. The system shows them available fractional slots and their prices. If desired, they can click a checkbox to pay extra for faster placement; the UI shows the adjusted price and an estimate of potential scheduling. After submission, the ad enters moderation; once approved, the user's ad is inserted into the shared playlist for the selected screens. They can track its status via the portal. If they chose priority, they see that their ad jumped ahead in the queue, and others'ads were rescheduled (and those advertisers received credit messages). All of these dynamics happen behind the scenes via the described modules.

This integrated approach is novel because no existing DOOH service combines fractional, algorithmic time-slicing, parallel B2B/B2C portals, AI moderation with audit logging, and a compensatory surge feature in one platform. The result is a highly flexible and defensible system that expands DOOH participation to new advertiser segments while maintaining strict content control and transparency.

Key aspects of the disclosed system and method:
1. A distributed digital advertising system for digital out-of-home (DOOH) media, comprising:
   an inventory module configured to acquire large-time-slot advertising inventory from DOOH media owners or aggregators;
   an allocation engine configured to subdivide each acquired large-time-slot into multiple smaller fractional time segments;
   a scheduling engine that assigns said fractional segments to advertisement requests based on advertiser-specified criteria;
   a first user interface portal for business advertisers, providing campaign creation, budgeting, targeting, and scheduling controls;
   a second user interface portal for personal advertisers (individuals), providing message templates, board selection, and simplified scheduling;
   a content moderation engine employing machine-learning models to automatically review submitted ad content for compliance with brand safety and regulatory guidelines, and to route ambiguous cases to human moderators;
   a priority management module that, upon receiving a priority-placement request and surcharge payment from an advertiser, dynamically reschedules existing fractional ads to accommodate the priority ad and applies compensation credits to any displaced advertisers from the surcharge pool;
   an emergency override module configured to interrupt scheduled advertising and display emergency alert content on designated DOOH screens when triggered by an external alert;
   a reporting module that provides media owners with a centralized dashboard for screen inventory management, API integration, campaign scheduling, and performance analytics;
   and a logging subsystem that records every scheduling change, moderation decision, priority-placement event, and emergency override in a secure audit log.
2. Further, the allocation engine continuously monitors available inventory and demand and automatically updates the fractional segment assignments in real time as new advertisement requests are received.
3. Further, the first portal (B2B) supports multi-screen and multi-campaign scheduling with business analytics, and the second portal (B2C) offers pre-defined message templates and localized board mapping for individual users.
4. Further, the content moderation engine includes filters for hate speech, explicit imagery, copyrighted materials, and underage personal data, and where all moderation results are stored with time stamps for auditability.
5. Further, the priority management module implements a surge pricing model that dynamically adjusts the surcharge based on current demand, and wherein displaced advertisers receive a partial refund or future credit funded from the surcharge.
6. Further, the emergency override module subscribes to public safety alerts (such as weather or Amber alerts) and, upon activation, causes all screens flagged as emergency-capable to immediately display standardized alert graphics until cleared.
7. Further, the system includes a cloud-based microservices architecture wherein each module communicates via secure APIs, and an event-driven messaging pipeline propagates scheduling updates to distributed service instances.
8. Further, every modification to the advertisement schedule caused by a priority placement or emergency override is logged to the audit subsystem to ensure transparency to all advertisers.
9. Further, the reporting module supports export of performance metrics and compliance reports, and provides a REST API for external integration with advertising platforms.
10. A computer-implemented method of fractional DOOH advertising, comprising:
   receiving information about a large advertising slot on a DOOH display;
   algorithmically dividing the large advertising slot into multiple fractional time segments;
   receiving advertisement booking requests from multiple advertisers (including both businesses and individuals), each request specifying content and a desired fraction or range of time;
   automatically reviewing each submitted advertisement through an AI-based moderation workflow for brand safety and regulatory compliance, escalating content with ambiguity to human reviewers;
   scheduling the approved advertisements into available fractional segments according to the requests;
   receiving a request from an advertiser to prioritize its ad by paying a surcharge, and, in response, reallocating existing scheduled fractional advertisements to accommodate the priority ad, and issuing compensation to any displaced advertisers from the surcharge funds;
   monitoring for emergency alert signals and, if detected, preemptively interrupting the current schedule to display the alert content on designated screens;
   and logging each scheduling decision, moderation decision, and override action to a secure audit log.
11. Further, scheduling the approved advertisements includes optimizing assignments based on advertiser targeting parameters such as location, time of day, and demographic attributes.
12. Further, the AI-based moderation applies text and image classifiers to detect prohibited content (e.g. profanity, hate symbols, copyrighted images) and ensures compliance with privacy laws (e.g. GDPR consent, COPPA for minors) before approving an ad.
13. Further, the surcharge price for prioritization is dynamically calculated according to real-time demand levels, and wherein the method includes computing each displaced advertiser's credit amount and applying the credits automatically to their accounts.
14. Further, the emergency alert override is initiated by receiving a signal from a public safety API, and the override displays the alert for a predefined duration before automatically returning to the regular ad schedule.
15. Further, the method may include providing a web-based control panel to media owners for uploading inventory data, setting screen availability, and viewing delivered ad logs and analytics dashboards.

The B2C component is a user-facing interface accessible via a website and/or mobile application. It allows consumers to generate, review, geotarget, pay for, and upload personal messages. Users can select the duration for which their message should be displayed and receive a dynamically generated rate based on current demand and regional pricing. The B2C component may be configured to communicate with the central management service via a secure API to submit approved messages for scheduling and display. It also receives feedback from the central management service regarding the status and timing of message displays. For high-priority messages, users can opt for surge pricing, enabling immediate display, when available. Feedback from media owners ensures transparency, allowing users to confirm when their message is displayed. The B2C component includes geolocation capabilities, enabling users to identify nearby DOOH screens for message display. This feature relies on an up-to-date catalog of screen inventory provided by media vendors. The B2C component may offer integration with third-party services, such as dating apps or greeting card websites, allowing users to send messages directly to DOOH screens as a value-added service.

The B2B component is a business-facing interface, also accessible via a website or mobile application. It enables businesses to upload advertisement assets and copy for review and approval. Once approved, ads are submitted to the central management service for scheduling. Similar to the B2C component, the B2B component interfaces with the central management service via a secure API. It receives scheduling information and feedback on ad performance from the central management service.

Unlike traditional full-slot purchases, this system enables businesses to share a single slot with multiple advertisers, reducing costs while increasing reach. The B2B component may include tools for creative assistance, acting as an independent agency for SMBs, NGOs, and other organizations. This could involve AI-generated content to reduce costs and enhance the value proposition. The B2B component might offer API functionality for approved third-party partners to submit ads for display, expanding the platform's reach and utility.

The platform may include a central management service that acts as the operational core of the system, maintaining bidirectional connections with DOOH media providers. It oversees ad scheduling and determines the order of ad displays based on factors such as service level, advertiser seniority, and media owner availability. The central management service can be configured to receive input from both the B2C and B2B components, process this information, and communicate with media vendors to manage ad displays. It also provides feedback to the B2C and B2B components regarding display status and performance.

The platform may include Central Management Service (CMS) or Central Scheduling Service (CSS) which incorporates specialized microservices such as inventory management, fractional scheduling, AI-driven moderation, surge prioritization, transaction handling, notification services, and audit logging. Further, both B2B and B2C interfaces communicate directly with these backend microservices, ensuring a cohesive and scalable solution. Although the process might be a little different for each, depending on the embodiment.

Further, B2C content submissions undergo rapid AI moderation equivalent to B2B submissions, eliminating any unnecessary delay, such as a full-day waiting period. Further, the moderation microservices may include the real-time or near-real-time capabilities of the moderation microservices, with manual review reserved for highly nuanced and ambiguous cases.

Further, the platform uniquely purchases entire advertising slots at wholesale rates and subdivides them into fractional segments dynamically, distinguishing this from typical industry practices.

Further, the platform follows a distinctive mechanism where advertisers pay a premium surcharge for prioritized ad placement, and displaced advertisers receive automated monetary compensation. Further, the distinctive mechanism clearly differentiates the disclosed platform from existing dynamic pricing models.

Further, the platform may include comprehensive logging for moderation decisions, scheduling adjustments, surge prioritization events, and financial transactions to enhance compliance and auditability

Further, the platform uniquely purchases entire advertising slots at wholesale rates (and/or unique privately negotiated rates for large entire blocks of slots) and subdivides the entire advertising slots into fractional segments dynamically, distinguishing the platform from typical industry practices.

The central management service operates independently from the B2C and B2B components, ensuring legal and regulatory separation between personal and business advertisements. It can be hosted on a separate cloud platform to maintain this separation. The central management service may incorporate advanced algorithms for optimizing ad scheduling and pricing, taking into account real-time data from media vendors and user interactions. The system may include enhanced geotargeting features, allowing businesses to target ads to specific consumer demographics. This would involve aggregating data from media owners and geographical databases to optimize ad placement. The system could support future technologies, such as VR headsets or refrigerator screens, by enabling asynchronous communication with these devices via APIs, without relying on NFC, Bluetooth, or WiFi. The system establishes relationships with media owners to negotiate favorable CPM rates, initially leveraging digital DSP platforms for broader geographic access.

Further, enhanced security features are added to protect sensitive advertising data and prevent unauthorized access. This improvement addresses potential security risks such as hacking or misuse of ad data. The implementation may include encryption protocols and multi-factor authentication mechanisms to secure user credentials and transaction records.

Further, the system may be integrated with an ad performance tracking system platform. This feature provides advertisers with detailed insights into their ad campaigns, enabling them to optimize their strategies for better results. The technical problem solved is the lack of transparency and feedback in traditional advertising systems. The implementation may include analytics tools that track metrics such as click-through rates, conversion rates, and impressions, along with A/B testing capabilities to refine ad creatives.

Further, cross-platform integration is enabled, allowing advertisers to manage their campaigns across multiple DOOH platforms seamlessly. This feature improves the overall efficiency of campaign management by streamlining operations across different networks. The technical problem addressed is the fragmentation of advertising systems that lack unified control. The implementation may involve developing APIs or middleware solutions that connect various platforms, enabling centralized campaign management and real-time data synchronization.

Further, the system may introduce customizable ad templates to allow advertisers to create their own branded content with specific design guidelines. This feature enhances the user experience by providing more control over how ads appear on DOOH screens. The technical problem solved is the lack of customization options in traditional advertising templates. The implementation may include tools that enable users to upload custom graphics and text, along with real-time previewing capabilities to ensure brand consistency.

Further, predictive analytics is integrated into the system to forecast audience behavior based on historical data and trends. This feature improves the accuracy of ad scheduling by enabling informed decisions about when and where ads should be displayed. The technical problem addressed is the reliance on outdated or incomplete data in traditional scheduling systems. The implementation may involve machine learning models that analyze past viewing patterns and demographic data, providing predictions for optimal ad placement times and locations.

Further, the present disclosure describes a system for facilitating dynamic and fractional advertisement scheduling.

Further, the system includes one or more Artificial Intelligence (AI) models configured to analyze advertisement data for the purpose of checking compliance with one or more brand safety guidelines and regulatory guidelines. Further, the AI models are machine learning models. The AI model(s) may include, but are not limited to, machine learning models such as deep neural networks, transformer-based language models, convolutional neural networks (CNNs), recurrent neural networks (RNNs), or hybrid architectures that combine multiple sub-models.

The AI model is executed using the processing device, which may include a central processing unit (CPU), a graphics processing unit (GPU), a tensor processing unit (TPU), or other suitable hardware accelerator capable of training, fine-tuning, and inference operations.

The system may receive advertisement data comprising text, images, video, audio, or any combination thereof. The processing device may preprocess this data by performing one or more of the following operations:
Textual Data: Tokenization, stop-word removal, stemming or lemmatization, embedding generation using word embeddings (e.g., Word2Vec, BERT embeddings), and sequence encoding.
Visual Data: Object detection, segmentation, feature extraction using a CNN backbone, frame sampling for videos, and conversion into feature maps or vectors.
Audio Data: Transcription, sentiment extraction, or keyword spotting. The preprocessed data is formatted into feature vectors suitable for input to the AI model.

In some embodiments, the AI model may be initialized using weights derived from a pre-trained model. The pre-trained model may be trained on large-scale general-purpose datasets, such as:
Text: A language model trained on web-scale corpora.
Images: An image classifier trained on ImageNet or a similar dataset.
Video: An action recognition model pre-trained on a video dataset.

This use of pre-trained weights reduces the computational resources needed to train a compliance-specific model from scratch.

The system employs transfer learning to adapt the pre-trained AI model to the specific domain of advertisement compliance. In one embodiment, transfer learning is implemented by fine-tuning some or all layers of the pre-trained model using a compliance dataset that contains labeled examples of compliant and non-compliant advertisement content.

The compliance dataset may include text samples marked for offensive language, misleading claims, or restricted topics; images flagged for prohibited visuals; or video segments violating regulatory standards. Fine-tuning may be performed using supervised learning techniques, gradient descent optimization, and regularization to prevent overfitting.

The adapted model retains general-purpose learned features while specializing its parameters for compliance detection.

During operation, the processing device inputs the preprocessed advertisement data into the adapted AI model. The model performs inference to output a compliance score, which may be:
A probability indicating the likelihood of compliance.
A categorical label (e.g., “Compliant” or “Non-Compliant”).
A multi-class label indicating the type of compliance violation, if any.

The compliance score may be calculated by applying a final classification layer with a softmax or sigmoid activation function. The output may include one or more confidence scores or explanatory metadata.

In one embodiment, a transformer-based language model, such as BERT, may be pre-trained on general text data and fine-tuned using a custom compliance dataset that includes flagged advertising copy. The fine-tuned model receives tokenized text, generates embeddings, processes the embeddings through its encoder layers, and outputs a compliance probability. For images, a CNN may be pre-trained on ImageNet, then fine-tuned with labeled examples of compliant/non-compliant ads to detect restricted imagery.

The described AI model may be implemented as software instructions stored in non-transitory memory and executed by the processing device. The processing device may include hardware accelerators (e.g., GPUs) for efficient matrix computation, and may use open-source or proprietary machine learning frameworks, such as TensorFlow or PyTorch.

The one or more processors or processing devices executing stored machine-readable instructions to perform the functions described herein, including preprocessing input data, loading and fine-tuning pre-trained models, executing inference operations, generating scores, and outputting results for use in scheduling decisions.

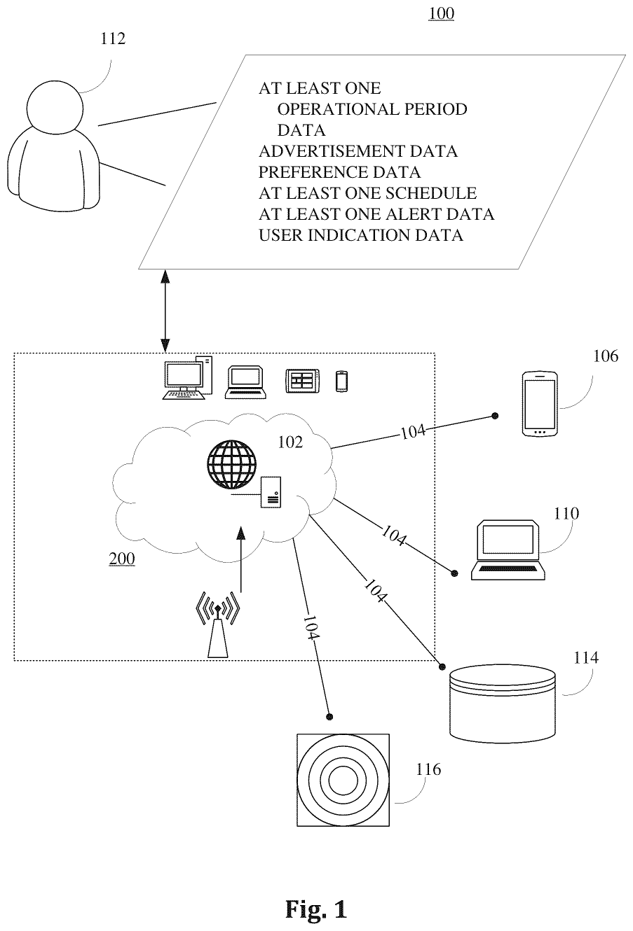

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

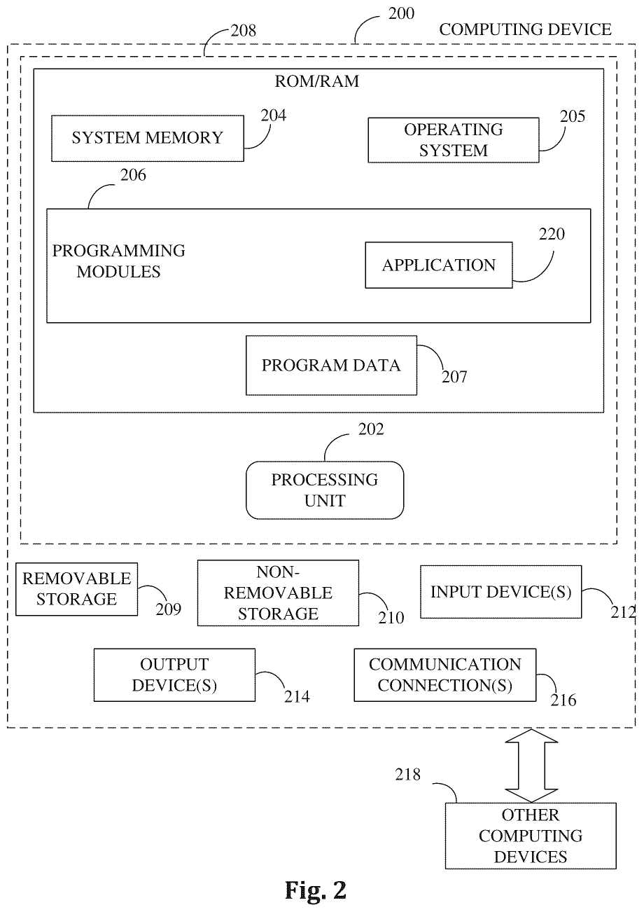

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

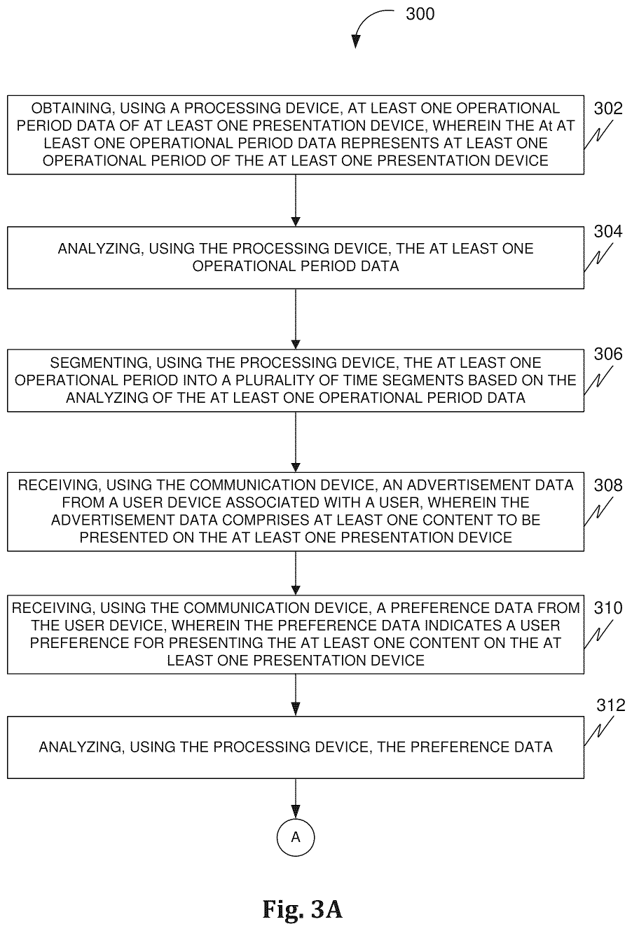

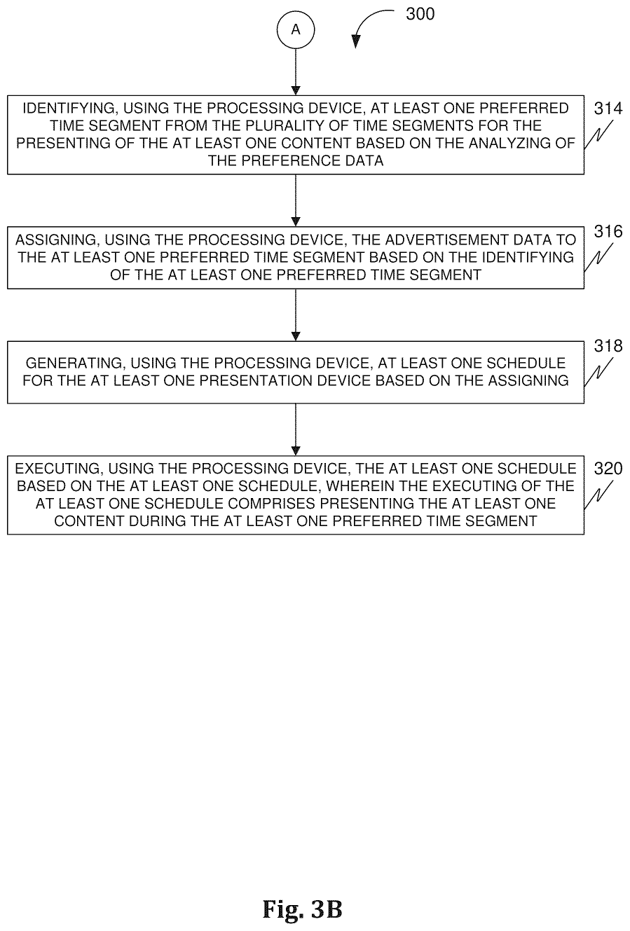

FIG. 3A and FIG. 3B illustrate a flowchart of a method 300 of facilitating dynamic and fractional advertisement scheduling, in accordance with some embodiments.

Accordingly, the method 300 may include a step 302 of obtaining, using a processing device 802, one or more operational period data of one or more presentation devices. Further, the one or more operational period data represents one or more operational periods of the one or more presentation devices. Further, the one or more operational periods correspond to one or more time durations. Further, the one or more time durations may include days, week, months, years, etc. Further, the one or more operational periods may include an period of the one or more time duration for which the one or more presentation devices may be active for presenting advertisement data. Further, the one or more operational periods may include a large-time-slot advertising inventory. Further, the one or more operational periods may include an advertisement (ad) slots, DOOH media slots, etc.

Further, the method 300 may include a step 304 of analyzing, using the processing device 802, the one or more operational period data.

Further, the method 300 may include a step 306 of segmenting, using the processing device 802, the one or more operational periods into two or more time segments based on the analyzing of the one or more operational period data.

Further, the method 300 may include a step 308 of receiving, using the communication device 804, an advertisement data from a user device 806 associated with a user. Further, the advertisement data includes one or more contents to be presented on the one or more presentation devices.

Further, the method 300 may include a step 310 of receiving, using the communication device 804, a preference data from the user device. Further, the preference data indicates a user preference for presenting the one or more contents on the one or more presentation devices.

Further, the method 300 may include a step 312 of analyzing, using the processing device 802, the preference data.

Further, the method 300 may include a step 314 of identifying, using the processing device 802, one or more preferred time segments from the two or more time segments for the presenting of the one or more contents based on the analyzing of the preference data.

Further, the method 300 may include a step 316 of assigning, using the processing device 802, the advertisement data to the one or more preferred time segments based on the identifying of the one or more preferred time segments.

Further, the method 300 may include a step 318 of generating, using the processing device 802, one or more schedules for the one or more presentation devices based on the assigning.

Further, the method 300 may include a step 320 of executing, using the processing device 802, the one or more schedules based on the one or more schedules. Further, the executing of the one or more schedules includes presenting the one or more contents during the one or more preferred time segments.

Further, in some embodiments, the method 300 may include retrieving, using the storage device, one or more previous advertisement data and one or more previous preference data associated with the one or more advertisement data. Further, the one or more advertisement data may include one or more content required to be presented on the one or more presentation devices during the one or more operational periods. Further, the method 300 may include analyzing, using the processing device, the one or more previous advertisement data and the one or more previous preference data. Further, the method 300 may include determining, using the processing device, the two or more time segments based on the analyzing of the one or more previous advertisement data and the one or more previous preference data. Further, the determining of the two or more time segments may include determining a number of the two or more time segments, and a duration of the two or more time segments. Further, the segmenting of the one or more operational periods may be further based on the determining of the two or more time segments.

Further, in an embodiment, the method 300 may include analyzing, using the processing device, the advertisement data and the preference data. Further, the determining of the two or more segments may be further based on the analyzing of the advertisement data and the preference data.

Further, in some embodiments, the method 300 may include analyzing, using the processing device, the at least one schedule. Further, the determining of the two or more segments may be further based on the analyzing of the at least one schedule.

Further, in an embodiment, the method 300 may include receiving, using the communication device, at least one request from at least one device. Further, the method 300 may include analyzing, using the processing device, the at least one request. Further, the method 300 may include, using the processing device, at least one modification in at least one previous schedule based on the analyzing of the at least one request. Further, the method 300 may include modifying, using the processing device, the at least one previous schedule based on the at least one modification. Further, the generating of the at least one schedule may be further based on the modifying of the at least one previous schedule.

In some embodiments, the one or more schedules indicate the one or more schedules of two or more advertisement data in the two or more time segments. Further, the user preference corresponds to prioritizing the advertisement data for the one or more preferred time segments. Further, the assigning of the advertisement data includes assigning the advertisement data to the one or more preferred time segments by a dynamic allocation of a second advertisement data from the one or more preferred time segments to one or more of the two or more time segments. Further, the two or more advertisement data include the second advertisement data. Further, the one or more of the two or more time segments may be different from the one or more preferred time segments.

In some embodiments, the method 300 may further include analyzing, using the processing device 802, the advertisement data using one or more Artificial Intelligence (AI) models. Further, the one or more AI models may be configured to check a compliance of the one or more contents with one or more of a brand safety guideline and a regulatory guideline. Further, the assigning of the advertisement data to the one or more preferred time segments may be further based on the analyzing of the advertisement data.

Further, in an embodiment, the analyzing of the advertisement data using the one or more Artificial Intelligence (AI) models may include preprocessing the advertisement data to extract one or more features relevant to check the compliance. Further, the analyzing of the advertisement data using the one or more Artificial Intelligence (AI) model may include adapting a pre-trained AI model by applying a transfer learning technique based on a compliance training dataset. Further, the one or more AI models may include the pre-trained AI model. Further, the analyzing of the advertisement data using the one or more Artificial Intelligence (AI) models may include generating one or more compliance scores indicating a compliance status of the one or more contents with the one or more of the brand safety guideline and the regulatory guideline. Further, the assigning of the advertisement data to the one or more preferred time segments may be further based on the one or more compliance scores.

Further, in an embodiment, the preprocessing of the advertisement data may include tokenizing a textual content comprised in the one or more contents, extracting visual features from visual content comprised in the one or more contents, and generating one or more feature vectors for input to the pre-trained AI model.

Further, in an embodiment, the adapting of the pre-trained AI model using the transfer learning technique may include fine-tuning one or more model layers of the pre-trained AI model using the compliance training dataset comprising labeled examples of compliant contents and non-compliant contents.

Further, in an embodiment, the generating of the one or more compliance scores further includes calculating a probability score for each of the one or more contents and classifying the one or more contents as either one of compliant and non-compliant based on a threshold.

In some embodiments, the segmenting of the one or more operational periods into the two or more time segments includes segmenting the one or more operational periods into the two or more time segments using one or more fractional scheduling engines. Further, the one or more fractional scheduling engines may be configured to algorithmically segment the one or more operational periods into the two or more time segments.

In some embodiments, the method 300 may further include determining, using the processing device 802, one or more parameters using one or more fractional scheduling engines based on the analyzing of the preference data. Further, the identifying of the one or more preferred time segments may be further based on the determining of the one or more parameters using the one or more fractional scheduling engines. Further, the one or more preferred time segments may be characterized by the one or more parameters.

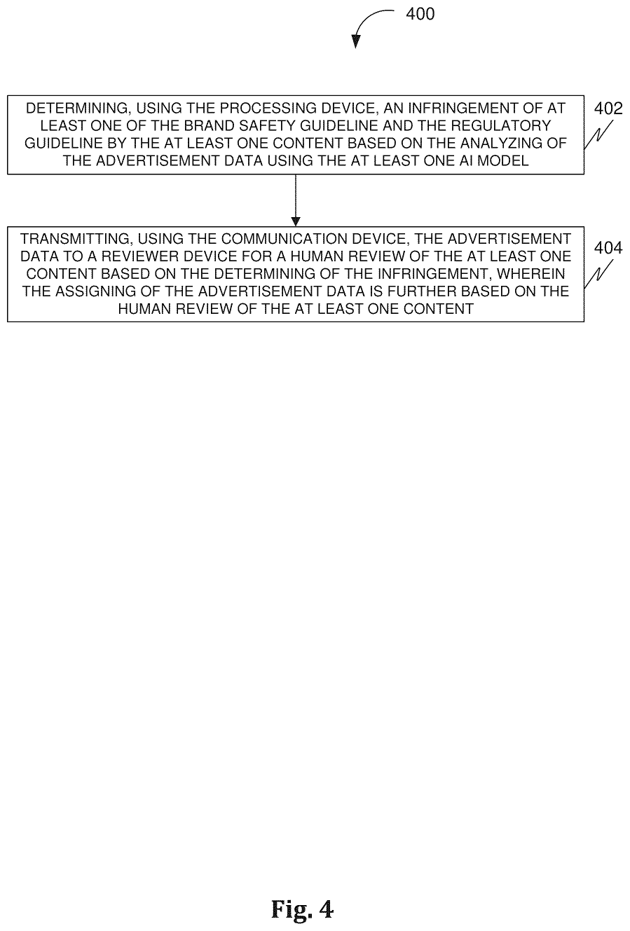

FIG. 4 illustrates a flowchart of a method 400 of facilitating dynamic and fractional advertisement scheduling including determining, using the processing device 802, an infringement of at least one of the brand safety guideline and the regulatory guideline by the at least one content, in accordance with some embodiments. Further, in some embodiments, the method 400 further may include a step 402 of

determining, using the processing device 802, an infringement of one or more of the brand safety guideline and the regulatory guideline by the one or more contents based on the analyzing of the advertisement data using the one or more AI models. Further, in some embodiments, the method 400 further may include a step 404 of transmitting, using the communication device 804, the advertisement data to a reviewer device for a human review of the one or more contents based on the determining of the infringement. Further, the assigning of the advertisement data may be further based on the human review of the one or more contents.

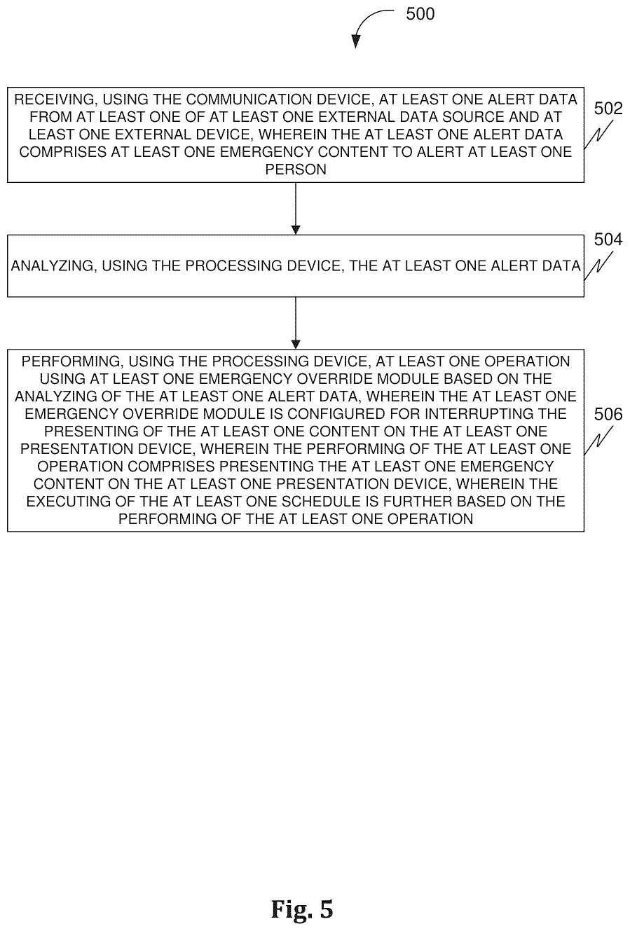

FIG. 5 illustrates a flowchart of a method 500 of facilitating dynamic and fractional advertisement scheduling including performing, using the processing device 802, at least one operation using at least one emergency override module, in accordance with some embodiments.

Further, in some embodiments, the method 500 further may include a step 502 of receiving, using the communication device 804, one or more alert data from one or more of one or more external data sources and one or more external devices. Further, the one or more alert data includes one or more emergency contents to alert one or more people. Further, in some embodiments, the method 500 further may include a step 504 of analyzing, using the processing device 802, the one or more alert data. Further, in some embodiments, the method 500 further may include a step 506 of performing, using the processing device 802, one or more operations using one or more emergency override modules based on the analyzing of the one or more alert data. Further, the one or more emergency override modules may be configured for interrupting the presenting of the one or more contents on the one or more presentation devices. Further, the performing of the one or more operations includes presenting the one or more emergency contents on the one or more presentation devices. Further, the executing of the one or more schedules may be further based on the performing of the one or more operations.

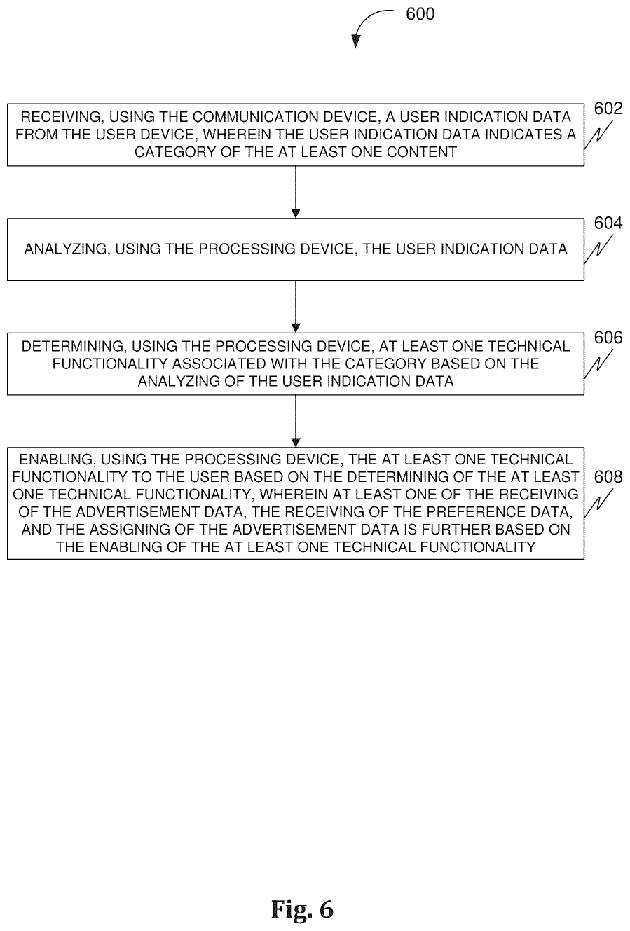

FIG. 6 illustrates a flowchart of a method 600 of facilitating dynamic and fractional advertisement scheduling including enabling, using the processing device 802, the at least one technical functionality to the user, in accordance with some embodiments.

Further, in some embodiments, the method 600 further may include a step 602 of receiving, using the communication device 804, a user indication data from the user device. Further, the user indication data indicates a category of the one or more contents. Further, in some embodiments, the method 600 further may include a step 604 of analyzing, using the processing device 802, the user indication data. Further, in some embodiments, the method 600 further may include a step 606 of determining, using the processing device 802, one or more technical functionalities associated with the category based on the analyzing of the user indication data. Further, in some embodiments, the method 600 further may include a step 608 of enabling, using the processing device 802, the one or more technical functionalities to the user based on the determining of the one or more technical functionalities. Further, one or more of the receiving of the advertisement data, the receiving of the preference data, and the assigning of the advertisement data may be further based on the enabling of the one or more technical functionalities.

In some embodiments, the assigning of the advertisement data to the one or more preferred time segments includes assigning of the advertisement data to the one or more preferred time segments using one or more fractional scheduling engines. Further, the one or more scheduling engines may be configured to use a scheduling algorithm for the dynamic allocation.

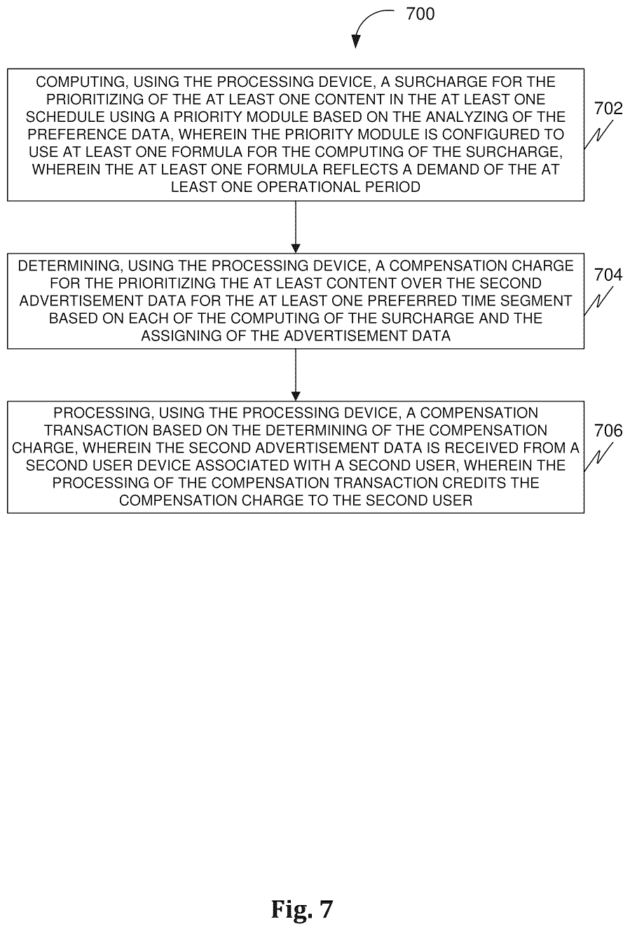

FIG. 7 illustrates a flowchart of a method 700 of facilitating dynamic and fractional advertisement scheduling including processing, using the processing device 802, a compensation transaction, in accordance with some embodiments.

Further, in some embodiments, the method 700 further may include a step 702 of computing, using the processing device 802, a surcharge for the prioritizing of the one or more contents in the one or more schedules using a priority module based on the analyzing of the preference data. Further, the priority module may be configured to use one or more formulas for the computing of the surcharge. Further, the one or more formulas reflect a demand of the one or more operational periods. Further, in some embodiments, the method 700 further may include a step 704 of determining, using the processing device 802, a compensation charge for the prioritizing the at least one content over the second advertisement data for the one or more preferred time segments based on each of the computing of the surcharge and the assigning of the advertisement data. Further, in some embodiments, the method 700 further may include a step 706 of processing, using the processing device 802, a compensation transaction based on the determining of the compensation charge. Further, the second advertisement data may be received from a second user device associated with a second user. Further, the processing of the compensation transaction credits the compensation charge to the second user.

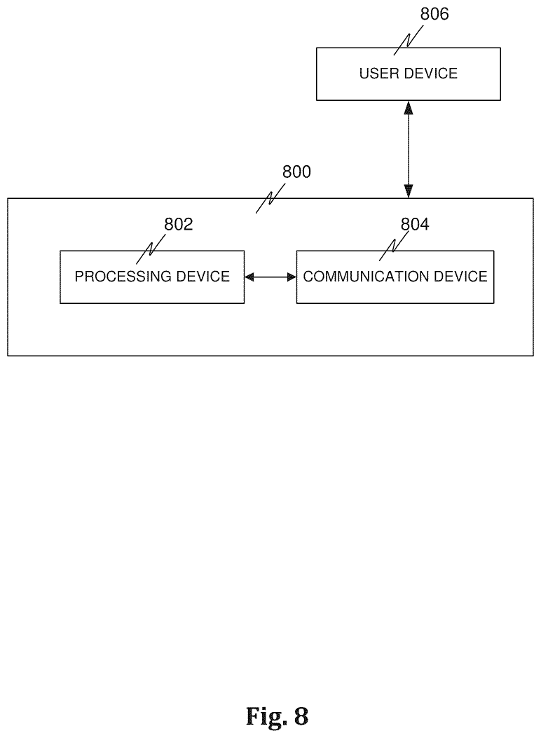

FIG. 8 illustrates a block diagram of a system 800 of facilitating dynamic and fractional advertisement scheduling, in accordance with some embodiments. A

ccordingly, the system 800 may include a processing device 802. Further, the processing device 802 may be configured for obtaining one or more operational period data of one or more presentation devices. Further, the one or more operational period data represents one or more operational periods of the one or more presentation devices. Further, the processing device 802 may be configured for analyzing the one or more operational period data. Further, the processing device 802 may be configured for segmenting the one or more operational periods into two or more time segments based on the analyzing of the one or more operational period data. Further, the processing device 802 may be configured for analyzing a preference data. Further, the processing device 802 may be configured for identifying one or more preferred time segments from the two or more time segments for presenting one or more contents based on the analyzing of the preference data. Further, the processing device 802 may be configured for assigning advertisement data to the one or more preferred time segments based on the identifying of the one or more preferred time segments. Further, the processing device 802 may be configured for generating one or more schedules for the one or more presentation devices based on the assigning. Further, the processing device 802 may be configured for executing the one or more schedules based on the one or more schedules. Further, the executing of the one or more schedules includes presenting the one or more contents during the one or more preferred time segments. Further, the system 800 may include a communication device 804 communicatively coupled with the processing device 802. Further, the communication device 804 may be configured for receiving the advertisement data from a user device 806 associated with a user. Further, the advertisement data includes the one or more contents to be presented on the one or more presentation devices. Further, the communication device 804 may be configured for receiving the preference data from the user device. Further, the preference data indicates a user preference for the presenting of the one or more contents on the one or more presentation devices.

In some embodiments, the one or more schedules indicates the one or more schedules of two or more advertisement data in the two or more time segments. Further, the user preference corresponds to prioritizing the advertisement data for the one or more preferred time segments. Further, the assigning of the advertisement data includes assigning the advertisement data to the one or more preferred time segments by a dynamic allocation of a second advertisement data from the one or more preferred time segments to one or more of the two or more time segments. Further, the two or more advertisement data includes the second advertisement data. Further, the one or more of the two or more time segments may be different from the one or more preferred time segments.

In some embodiments, the processing device 802 may be further configured for analyzing the advertisement data using one or more Artificial Intelligence (AI) models. Further, the one or more AI models may be configured to check a compliance of the one or more contents with one or more of a brand safety guideline and a regulatory guideline. Further, the assigning of the advertisement data to the one or more preferred time segments may be further based on the analyzing of the advertisement data.

In some embodiments, the segmenting of the one or more operational periods into the two or more time segments includes segmenting the one or more operational periods into the two or more time segments using one or more fractional scheduling engines. Further, the one or more fractional scheduling engines may be configured to algorithmically segment the one or more operational periods into the two or more time segments.

In some embodiments, the processing device 802 may be further configured for determining one or more parameters using one or more fractional scheduling engines based on the analyzing of the preference data. Further, the identifying of the one or more preferred time segments may be further based on the determining of the one or more parameters using the one or more fractional scheduling engines. Further, the one or more preferred time segments may be characterized by the one or more parameters.

In some embodiments, the processing device 802 may be further configured for determining an infringement of one or more of the brand safety guideline and the regulatory guideline by the one or more contents based on the analyzing of the advertisement data using the one or more AI models. Further, the communication device 804 may be further configured for transmitting the advertisement data to a reviewer device for a human review of the one or more contents based on the determining of the infringement. Further, the assigning of the advertisement data may be further based on the human review of the one or more contents.

Further, in some embodiments, the communication device 804 may be further configured for receiving one or more alert data from one or more of one or more external data sources and one or more external devices. Further, the one or more alert data may include one or more emergency contents to alert one or more people. Further, the processing device 802 may be further configured for analyzing the one or more alert data performing one or more operations using one or more emergency override modules based on the analyzing of the one or more alert data. Further, the one or more emergency override modules may be configured for interrupting the presenting of the one or more contents on the one or more presentation devices. Further, the performing of the one or more operations includes presenting the one or more emergency contents on the one or more presentation devices. Further, the executing of the one or more schedules may be further based on the performing of the one or more operations.

Further, in some embodiments, the communication device 804 may be configured for receiving a user indication data from the user device. Further, the user indication data indicates a category of the one or more contents. Further, the processing device 802 may be further configured for analyzing the user indication data. Further, the processing device 802 may be further configured for determining one or more technical functionalities associated with the category based on the analyzing of the user indication data. Further, the processing device 802 may be further configured for enabling the one or more technical functionalities to the user based on the determining of the one or more technical functionalities. Further, one or more of the receiving of the advertisement data, the receiving of the preference data, and the assigning of the advertisement data may be further based on the enabling of the one or more technical functionalities.

In some embodiments, the assigning of the advertisement data to the one or more preferred time segments includes assigning of the advertisement data to the one or more preferred time segments using one or more fractional scheduling engines. Further, the one or more scheduling engines may be configured to use a scheduling algorithm for the dynamic allocation.

Further, in some embodiments, the processing device 802 may be further configured for computing a surcharge for the prioritizing of the one or more contents in the one or more schedules using a priority module based on the analyzing of the preference data. Further, the priority module may be configured to use one or more formulas for the computing of the surcharge. Further, the one or more formulas reflect a demand of the one or more operational periods. Further, the processing device 802 may be further configured for determining a compensation charge for the prioritizing the at least one content over the second advertisement data for the one or more preferred time segments based on each of the computing of the surcharge and the assigning of the advertisement data. Further, the processing device 802 may be further configured for processing a compensation transaction based on the determining of the compensation charge. Further, the second advertisement data may be received from a second user device associated with a second user. Further, the processing of the compensation transaction credits the compensation charge to the second user.

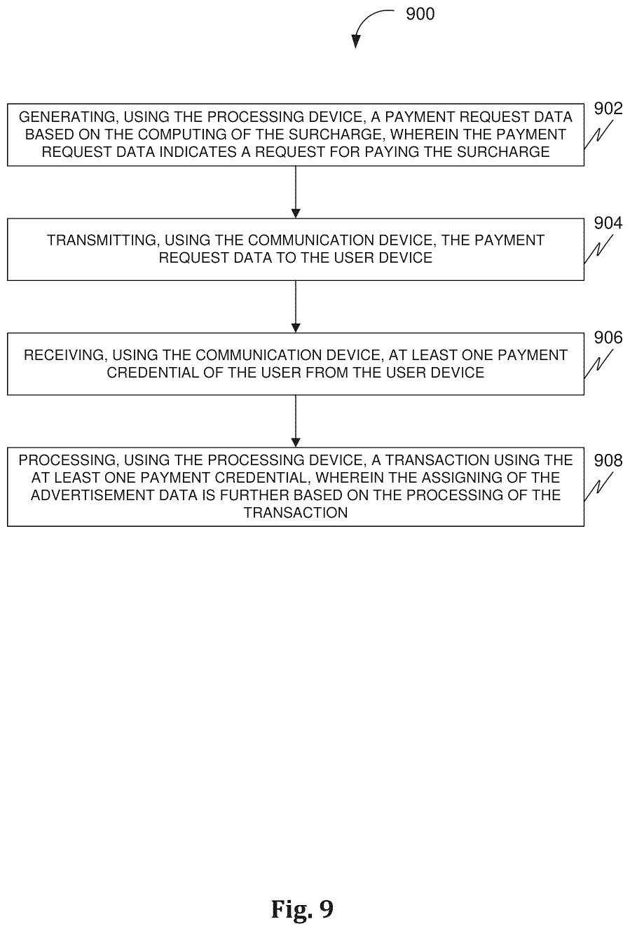

FIG. 9 illustrates a flowchart of a method 900 of facilitating dynamic and fractional advertisement scheduling including processing, using the processing device 802, a transaction using the at least one payment credential, in accordance with some embodiments.

Further, in some embodiments, the method 900 further may include a step 902 of generating, using the processing device 802, a payment request data based on the computing of the surcharge. Further, the payment request data indicates a request for paying the surcharge. Further, in some embodiments, the method 900 further may include a step 904 of transmitting, using the communication device 804, the payment request data to the user device. Further, in some embodiments, the method 900 further may include a step 906 of receiving, using the communication device 804, one or more payment credentials of the user from the user device. Further, in some embodiments, the method 900 further may include a step 908 of processing, using the processing device 802, a transaction using the one or more payment credentials. Further, the assigning of the advertisement data may be further based on the processing of the transaction.

In some embodiments, the identifying of the one or more preferred time segments includes identifying the one or more preferred time segments from the two or more time segments using one or more fractional scheduling engines. Further, the one or more fractional scheduling engines may be configured to recombine a cancelled time segment with the two or more time segments for the identifying of the one or more preferred time segments. Further, the cancelled time segment may be cancelled by a second user for presenting a second advertisement data.

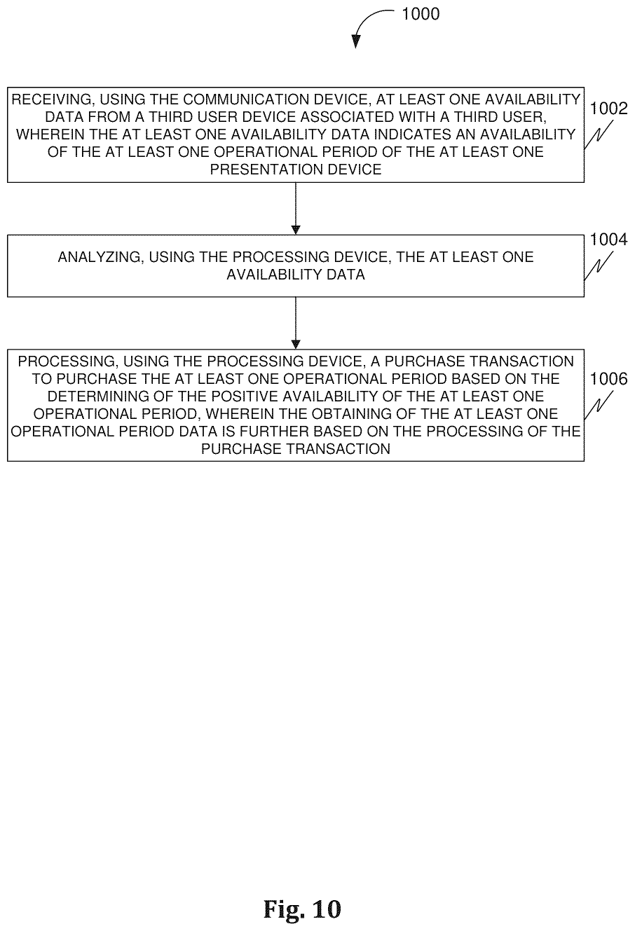

FIG. 10 illustrates a flowchart of a method 1000 of facilitating dynamic and fractional advertisement scheduling including processing, using the processing device 802, a purchase transaction to purchase the at least one operational period, in accordance with some embodiments.

Further, in some embodiments, the method 1000 further may include a step 1002 of receiving, using the communication device 804, one or more availability data from a third user device associated with a third user. Further, the one or more availability data indicates an availability of the one or more operational periods of the one or more presentation devices. Further, in some embodiments, the method 1000 further may include a step 1004 of analyzing, using the processing device 802, the one or more availability data. Further, in some embodiments, the method 1000 further may include a step 1006 of processing, using the processing device 802, a purchase transaction to purchase the one or more operational periods based on the determining of the positive availability of the one or more operational periods. Further, the obtaining of the one or more operational period data may be further based on the processing of the purchase transaction.

In some embodiments, the one or more operational periods of the one or more presentation devices may be purchased at a wholesale rate.

In some embodiments, the one or more operational periods of the one or more presentation devices may be purchased at a privately negotiated rate.

In some embodiments, the one or more operational periods may include an entire advertising slot of the one or more presentation devices.

In some embodiments, the segmenting of the one or more operational periods comprises dynamically segmenting the one or more operational periods into the two or more time segments.

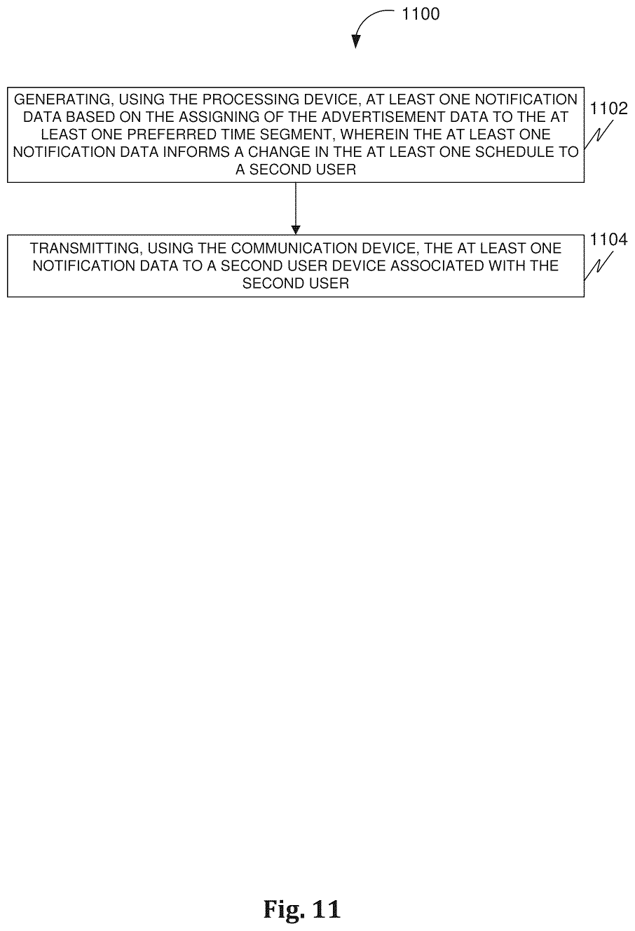

FIG. 11 illustrates a flowchart of a method 1100 of facilitating dynamic and fractional advertisement scheduling including generating, using the processing device 802, at least one notification data, in accordance with some embodiments.

Further, in some embodiments, the method 1100 further may include a step 1102 of generating, using the processing device 802, one or more notification data based on the assigning of the advertisement data to the one or more preferred time segments. Further, the one or more notification data informs a change in the one or more schedules to a second user. Further, in some embodiments, the method 1100 further may include a step 1104 of transmitting, using the communication device 804, the one or more notification data to a second user device associated with the second user.

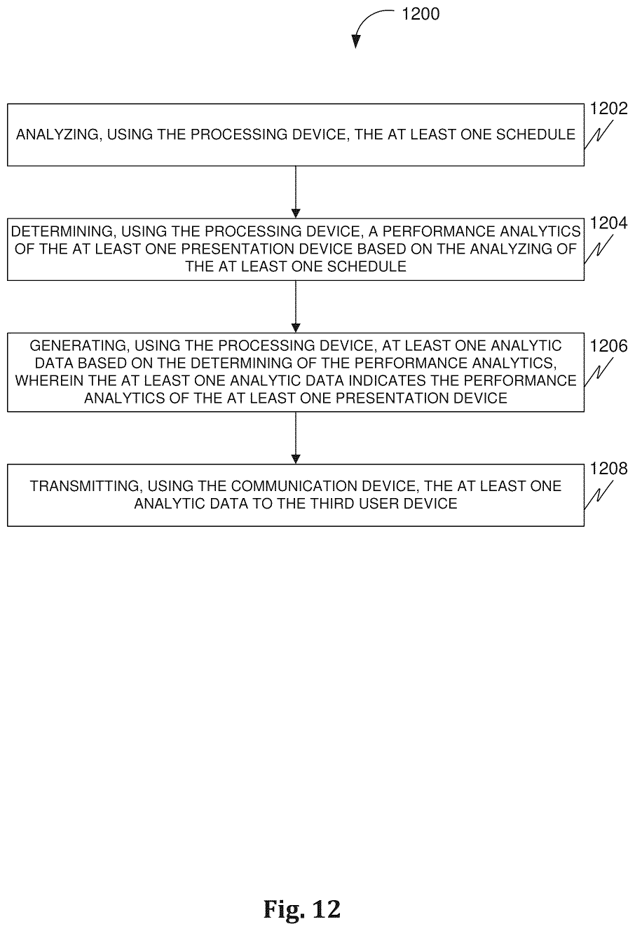

FIG. 12 illustrates a flowchart of a method 1200 of facilitating dynamic and fractional advertisement scheduling including generating, using the processing device 802, at least one analytic data, in accordance with some embodiments.

Further, in some embodiments, the method 1200 further may include a step 1202 of analyzing, using the processing device 802, the one or more schedules. Further, in some embodiments, the method 1200 further may include a step 1204 of determining, using the processing device 802, a performance analytics of the one or more presentation devices based on the analyzing of the one or more schedules. Further, in some embodiments, the method 1200 further may include a step 1206 of generating, using the processing device 802, one or more analytic data based on the determining of the performance analytics. Further, the one or more analytic data indicate the performance analytics of the one or more presentation devices. Further, in some embodiments, the method 1200 further may include a step 1208 of transmitting, using the communication device 804, the one or more analytic data to the third user device.

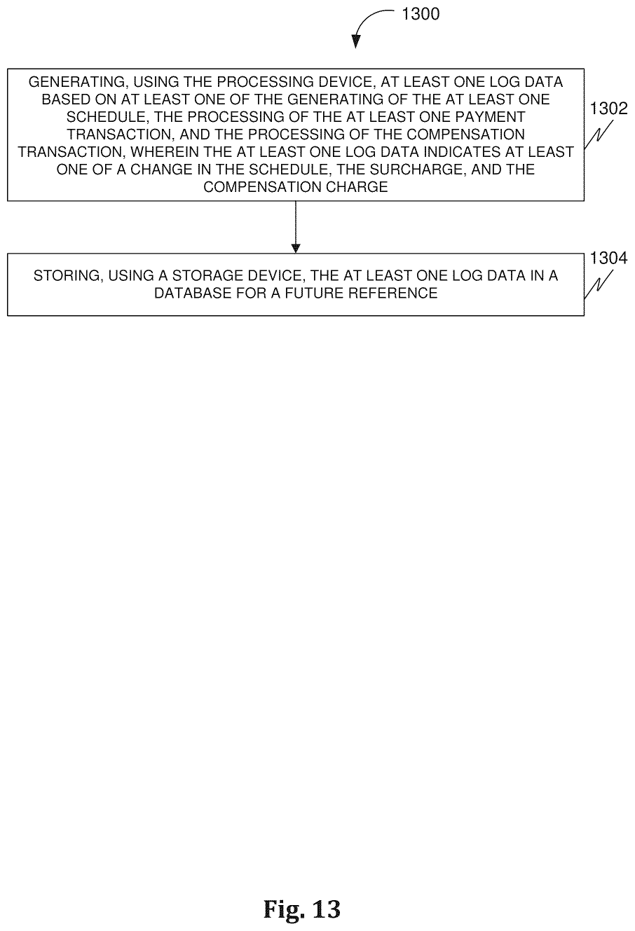

FIG. 13 illustrates a flowchart of a method 1300 of facilitating dynamic and fractional advertisement scheduling including generating, using the processing device 802, at least one log data, in accordance with some embodiments.

Further, in some embodiments, the method 1300 further may include a step 1302 of generating, using the processing device 802, one or more log data based on one or more of the generating of the one or more schedules, the processing of the one or more payment transactions, and the processing of the compensation transaction. Further, the one or more log data indicate one or more of a change in the schedule, the surcharge, and the compensation charge. Further, in some embodiments, the method 1300 further may include a step 1304 of storing, using a storage device, the one or more log data in a database for a future reference.

In some embodiments, the transmitting of the one or more analytical data of the one or more presentation devices and the storing of the one or more log data facilitate an inventory management.

In some embodiments, the method 1300 may facilitate an audit logging by the storing of the one or more log data.

In some embodiments, the one or more parameters include one or more of a count of the one or more preferred time segments and a duration of the one or more preferred time segments.

In some embodiments, the one or more presentation devices include one or more digital out-of-home (DOOH) devices. Further, the one or more presentation devices may include one or more media screens.

In some embodiments, the one or more AI models include one or more Machine Learning (ML) models.

In some embodiments, the one or more ML models may be trained for one or more of an image analysis, a video scanning, and a text sentiment analyzing. Further, the one or more contents correspond to one or more of an image, a video, and a text.

In some embodiments, the brand safety guideline and the regulatory guideline correspond to one or more of a brand safety criterion, a privacy law, and a copyright.

In some embodiments, the method 400 may further include receiving, using the communication device 804, a review data from the reviewer device. Further, the review data represents the result of the human review. Further, the assigning of the advertisement data to the one or more preferred time segments may be further based on the review data.

In some embodiments, the one or more user preferences correspond to one or more of a geographical location of the one or more presentation devices, a preferred time slot, and a targeting audience.

In some embodiments, the assigning of the advertisement data to the one or more preferred time segments includes assigning the advertisement data to each of a first preferred time segment and a second preferred time segment for the presenting of the one or more contents. Further, the two or more time segments include each of the first preferred time segment and the second preferred time segment.

In some embodiments, the one or more contents may be characterized by a content time duration. Further, the first preferred time segment may be less than the content time duration. Further, a sum of the first preferred time segment and the second preferred time segment may be greater than the content time duration.

In some embodiments, the category includes one or more of a commercial advertisement category and a personal message category.

In some embodiments, the one or more contents belong to the personal message category. Further, the enabling of the one or more technical functionalities may include enabling a rapid AI moderation equivalent to the one or more contents that belong to the commercial advertisement category. Further, the rapid AI moderation may eliminate a waiting period.

In some embodiments, the rapid AI moderation may include one or more of a real-time AI moderation and a near real-time AI moderation.

In some embodiments, the one or more contents may include a highly nuanced and ambiguous content. Further, the rapid-AI moderation may be associated with a manual review.

In some embodiments, the one or more contents belong to the commercial advertisement category. Further, the one or more technical functionalities correspond to one or more of creating a campaign, selecting a target, setting a budget, uploading creative content, setting two or more schedules, generating a performance analytics and assigning two or more preferred time segments of two or more presentation devices.

In some embodiments, the selecting of the target may be based on one or more of a geography, a time of day, and a demography.

In some embodiments, the user includes a business advertiser.

In some embodiments, the user may be associated with an agency.

In some embodiments, the one or more contents belong to the personal message category. Further, the one or more technical functionalities corresponds to one or more of presenting a themed template, providing a free-form design canvas for the one or more contents, presenting a map of one or more available presentation devices, purchasing the one or more preferred time segments in advance, and presenting one or more of a date picker and a time picker.

In some embodiments, the one or more contents belonging to the personal message category correspond to one or more of a birthday wish, a proposal, a greeting, and a small business content.

In some embodiments, the user may be associated with a small business.

In some embodiments, the user includes a personal advertiser.

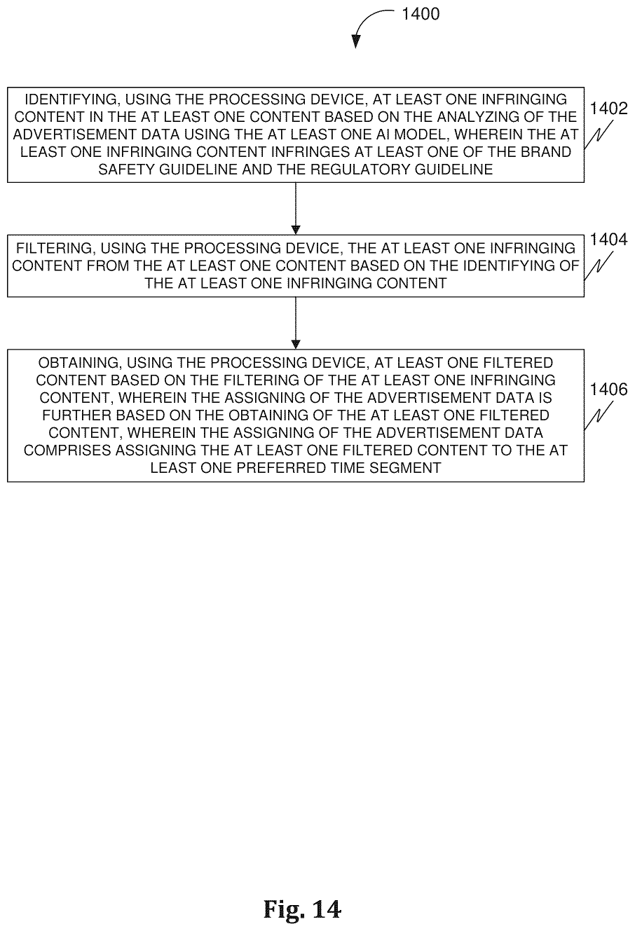

FIG. 14 illustrates a flowchart of a method 1400 of facilitating dynamic and fractional advertisement scheduling including obtaining, using the processing device 802, at least one filtered content, in accordance with some embodiments.

Further, in some embodiments, the method 1400 further may include a step 1402 of identifying, using the processing device 802, one or more infringing contents in the one or more contents based on the analyzing of the advertisement data using the one or more AI models. Further, the one or more infringing content infringe one or more of the brand safety guideline and the regulatory guideline. Further, in some embodiments, the method 1400 further may include a step 1404 of filtering, using the processing device 802, the one or more infringing contents from the one or more contents based on the identifying of the one or more infringing contents. Further, in some embodiments, the method 1400 further may include a step 1406 of obtaining, using the processing device 802, one or more filtered contents based on the filtering of the one or more infringing contents. Further, the assigning of the advertisement data may be further based on the obtaining of the one or more filtered contents. Further, the assigning of the advertisement data includes assigning the one or more filtered contents to the one or more preferred time segments.

In some embodiments, the one or more infringing contents include one or more of an adult content, a drug reference, and a hate speech.

In some embodiments, the one or more infringing contents correspond to one or more of an unlicensed logo and an unlicensed media.

In some embodiments, at least one of the brand safety guideline and the regulatory guideline corresponds to one or more of Children's Online Privacy Protection Act (COPPA) and General Data Protection Regulation (GDPR).

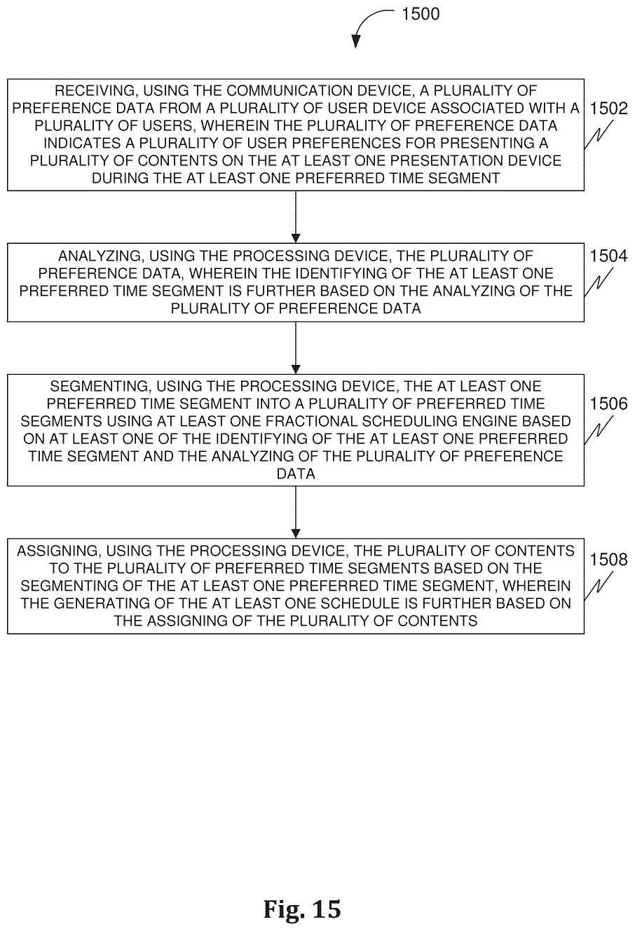

FIG. 15 illustrates a flowchart of a method 1500 of facilitating dynamic and fractional advertisement scheduling including assigning, using the processing device 802, the plurality of contents to the plurality of preferred time segments, in accordance with some embodiments.

Further, in some embodiments, the method 1500 further may include a step 1502 of receiving, using the communication device 804, two or more preference data from two or more user devices associated with two or more users. Further, the two or more preference data indicates two or more user preferences for presenting two or more contents on the one or more presentation devices during the one or more preferred time segments. Further, in some embodiments, the method 1500 further may include a step 1504 of analyzing, using the processing device 802, the two or more preference data. Further, the identifying of the one or more preferred time segments may be further based on the analyzing of the two or more preference data. Further, in some embodiments, the method 1500 further may include a step 1506 of segmenting, using the processing device 802, the one or more preferred time segments into two or more preferred time segments using one or more fractional scheduling engines based on one or more of the identifying of the one or more preferred time segments and the analyzing of the two or more preference data. Further, in some embodiments, the method 1500 further may include a step 1508 of assigning, using the processing device 802, the two or more contents to the two or more preferred time segments based on the segmenting of the one or more preferred time segments. Further, the generating of the one or more schedules may be further based on the assigning of the two or more contents.

In some embodiments, the method 300 may further include transmitting, using the communication device 804, the one or more schedules to the user device. Further, the user device 806 may be configured to present the one or more schedules on a user presentation device. Further, the user presentation device may be comprised in the user device. Further, the one or more schedules inform the one or more schedules of the advertisement data to the user.

In some embodiments, the one or more external data sources correspond to one or more of a government emergency system and a weather application programming interface (API).

In some embodiments, the one or more alert data includes one or more application programming interface (API) responses.

In some embodiments, the presenting of the one or more emergency contents on the one or more presentation devices includes presenting the one or more emergency contents on the one or more presentation devices for a predefined time interval. Further, the executing of the one or more schedules occurs after the predefined time interval.

In some embodiments, the method 1000 may further include transmitting, using the communication device 804, the one or more schedules to the third user device to inform the one or more schedules of the one or more presentation devices.

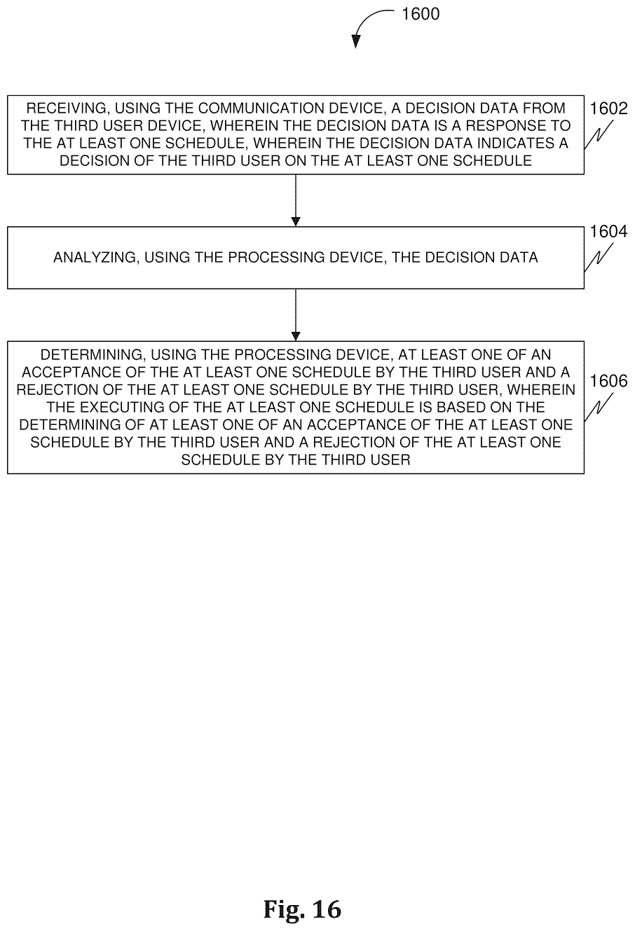

FIG. 16 illustrates a flowchart of a method 1600 of facilitating dynamic and fractional advertisement scheduling including determining, using the processing device 802, at least one of an acceptance of the at least one schedule by the third user and a rejection of the at least one schedule by the third user, in accordance with some embodiments.

Further, in some embodiments, the method 1600 further may include a step 1602 of receiving, using the communication device 804, a decision data from the third user device. Further, the decision data may be a response to the one or more schedules. Further, the decision data indicates a decision of the third user on the one or more schedules. Further, in some embodiments, the method 1600 further may include a step 1604 of analyzing, using the processing device 802, the decision data. Further, in some embodiments, the method 1600 further may include a step 1606 of determining, using the processing device 802, one or more of an acceptance of the one or more schedules by the third user and a rejection of the one or more schedules by the third user. Further, the executing of the one or more schedules may be based on the determining of one or more of an acceptance of the one or more schedules by the third user and a rejection of the one or more schedules by the third user.

In some embodiments, the performance analytics corresponds to one or more of a total advertisement impression, an estimated audience count, and an earned revenue.

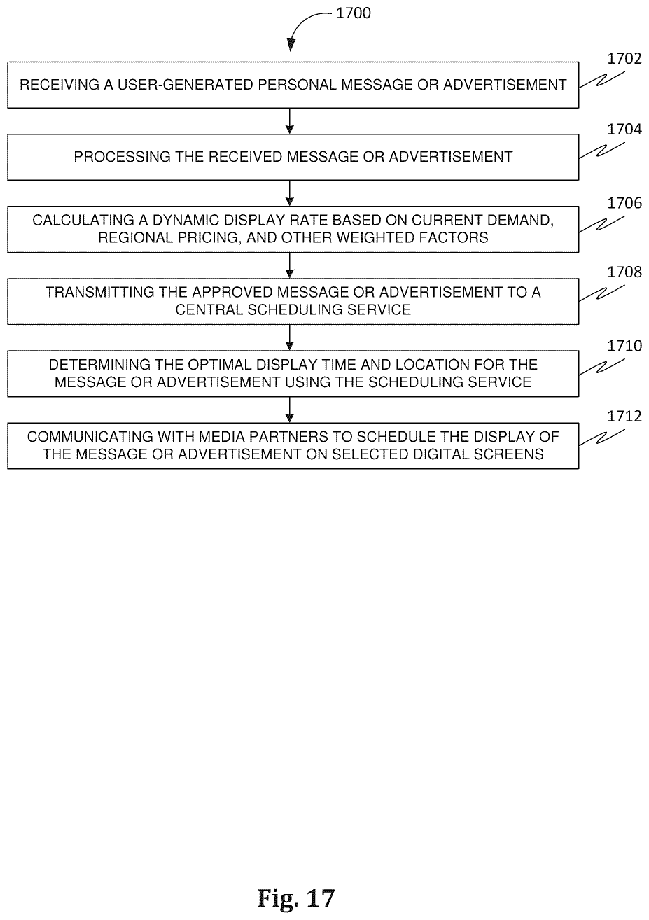

FIG. 17 illustrates a flowchart of a method 1700 of facilitating dynamic and fractional advertisement scheduling, in accordance with some embodiments. Further, the method 1700 may include a step 1702 of receiving a user-generated personal message or

advertisement via a user interface accessible through a website or mobile application. Further, the method 1700 may include a step 1704 of processing the received message or advertisement using an AI-based approval system to ensure compliance with local regulations and content standards. Further, the method 1700 may include a step 1706 of calculating a dynamic display rate based on current demand, regional pricing, and other weighted factors. Further, the method 1700 may include a step 1708 of transmitting the approved message or advertisement to a central scheduling service via a secure API. Further, the method 1700 may include a step 1710 of determining the optimal display time and location for the message or advertisement using the scheduling service, which considers factors such as service level, advertiser seniority, and media owner availability. Further, the method may include a step 1712 of communicating with media partners to schedule the display of the message or advertisement on selected digital screens.

In some embodiments, the method 1700 may include providing feedback to the user or business regarding the display status and timing of the message or advertisement.

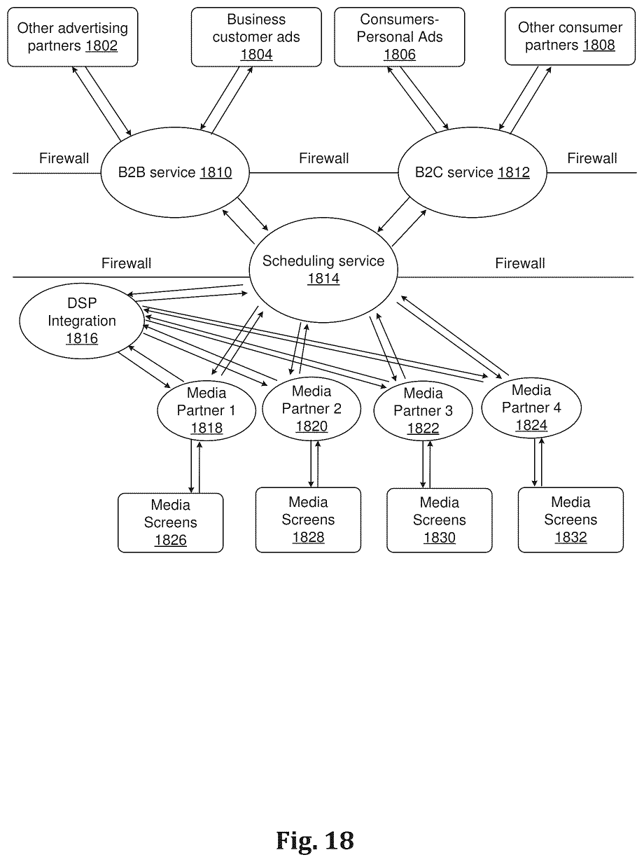

FIG. 18 illustrates a flowchart of a process of facilitating dynamic and fractional advertisement scheduling, in accordance with some embodiments. Further, the process may use a firewall to secure a traffic between a plurality of components. Further, one or more of a consumer personal advertisement 1806 is received from a consumer through one or more of an application and a website for a B2C service 1812. Further, the B2C service may be provided to other consumer partners 1808. Further, the other consumer partners may include one or more of a greeting card website and a dating application. Further, one or more traditional advertisement 1804 are received from a business customer through one or more of an application and a website for a B2B service 1810. Further, the B2B service may be provided to other advertising partner 1806. Further, each of the B2C service 1812 and B2B service 1814 may process the consumer personal advertisement 1806 and the one or more traditional advertisement 1804 respectively. Further, the B2C service 1812 and B2B service 1814 may ensure compliance of the consumer personal advertisement 1806 and the one or more traditional advertisement 1804 with a regulation using an AI model, respectively.

Further, the consumer personal advertisement 1806 and the one or more traditional advertisement 1804 may be sent to a scheduling service 1814. Further, the scheduling service 1814 may maintain a connection with two or more of media partners to determine an optimal display time based on a current demand and an availability. Further the scheduling service 1814 may be integrated with a DSP 1816 to optimize advertisement placement across various screens managed by one or more of the two or more of media partners. Further, the two or more of media partners may include a media partner 1818, a media partner 1820, a media partner 1822, and a media partner 1824. Further, the media partner 1818, the media partner 1820, the media partner 1822, and the media partner 1824 may be associated with media screens 1826, media screens 1830, media screens 1832, and media screens 1834 respectively.

Although the invention has been explained in relation to its preferred embodiment, it is to be understood that many other possible modifications and variations can be made without departing from the spirit and scope of the invention as hereinafter claimed.

What is claimed is:

1. A method of facilitating dynamic and fractional advertisement scheduling, the method comprising:
obtaining, using a processing device, at least one operational period data of at least one operational period of at least one presentation device, wherein the at least one operational period data represents at least one operational period of the at least one presentation device;
analyzing, using the processing device, the at least one operational period data;
segmenting, using the processing device, the at least one operational period into a plurality of time segments based on the analyzing of the at least one operational period data;
receiving, using the communication device, an advertisement data from a user device associated with a user, wherein the advertisement data comprises at least one content to be presented on the at least one presentation device;
receiving, using the communication device, a preference data from the user device, wherein the preference data indicates a user preference for presenting the at least one content on the at least one presentation device;
analyzing, using the processing device, the preference data;
identifying, using the processing device, at least one preferred time segment from the plurality of time segments for the presenting of the at least one content based on the analyzing of the preference data;
assigning, using the processing device, the advertisement data to the at least one preferred time segment based on the identifying of the at least one preferred time segment;
generating, using the processing device, at least one schedule for the at least one presentation device based on the assigning; and
executing, using the processing device, the at least one schedule, wherein the executing of the at least one schedule comprises presenting the at least one content during the at least one preferred time segment.

2. The method of claim 1, wherein the at least one schedule indicates the at least one schedule of a plurality of advertisement data in the plurality of time segments, wherein the user preference corresponds to prioritizing the advertisement data for the at least one preferred time segment, wherein the assigning of the advertisement data comprises assigning the advertisement data to the at least one preferred time segment by a dynamic allocation of a second advertisement data from the at least one preferred time segment to at least one of the plurality of time segments, wherein the plurality of advertisement data comprises the second advertisement data, wherein the at least one of the plurality of time segments is different from the at least one preferred time segment.

3. The method of claim 1 further comprising analyzing, using the processing device, the advertisement data using at least one Artificial Intelligence (AI) model, wherein the at least one AI model is configured to check a compliance of the at least one content with at least one of a brand safety guideline and a regulatory guideline, wherein the assigning of the advertisement data to the at least one preferred time segment is further based on the analyzing of the advertisement data.

4. The method of claim 1, wherein the segmenting of the at least one operational period into the plurality of time segments comprises segmenting the at least one operational period into the plurality of time segments using at least one fractional scheduling engine, wherein the at least one fractional scheduling engine is configured to algorithmically segment the at least one operational period into the plurality of time segments.

5. The method of claim 1 further comprising determining, using the processing device, at least one parameter using at least one fractional scheduling engine based on the analyzing of the preference data, wherein the identifying of the at least one preferred time segment is further based on the determining of the at least one parameter using the at least one fractional scheduling engine, wherein the at least one preferred time segment is characterized by the at least one parameter.

6. The method of claim 3 further comprising:
determining, using the processing device, an infringement of at least one of the brand safety guideline and the regulatory guideline by the at least one content based on the analyzing of the advertisement data using the at least one AI model; and
transmitting, using the communication device, the advertisement data to a reviewer device for a human review of the at least one content based on the determining of the infringement, wherein the assigning of the advertisement data is further based on the human review of the at least one content.

7. The method of claim 1 further comprising:
receiving, using the communication device, at least one alert data from at least one of at least one external data source and at least one external device, wherein the at least one alert data comprises at least one emergency content to alert at least one person;
analyzing, using the processing device, the at least one alert data; and
performing, using the processing device, at least one operation using at least one emergency override module based on the analyzing of the at least one alert data, wherein the at least one emergency override module is configured for interrupting the presenting of the at least one content on the at least one presentation device, wherein the performing of the at least one operation comprises presenting the at least one emergency content on the at least one presentation device, wherein the executing of the at least one schedule is further based on the performing of the at least one operation.

8. The method of claim 1 further comprising:
receiving, using the communication device, a user indication data from the user device, wherein the user indication data indicates a category of the at least one content;
analyzing, using the processing device, the user indication data;
determining, using the processing device, at least one technical functionality associated with the category based on the analyzing of the user indication data; and
enabling, using the processing device, the at least one technical functionality to the user based on the determining of the at least one technical functionality, wherein at least one of the receiving of the advertisement data, the receiving of the preference data, and the assigning of the advertisement data is further based on the enabling of the at least one technical functionality.

9. The method of claim 2, wherein the assigning of the advertisement data to the at least one preferred time segment comprises assigning of the advertisement data to the at least one preferred time segment using at least one fractional scheduling engine, wherein the at least one scheduling engine is configured to use a scheduling algorithm for the dynamic allocation.

10. The method of claim 2 further comprising:
computing, using the processing device, a surcharge for the prioritizing of the at least one content in the at least one schedule using a priority module based on the analyzing of the preference data, wherein the priority module is configured to use at least one formula for the computing of the surcharge, wherein the at least one formula reflects a demand of the at least one operational period;
determining, using the processing device, a compensation charge for the prioritizing the at least one content over the second advertisement data for the at least one preferred time segment based on each of the computing of the surcharge and the assigning of the advertisement data; and
processing, using the processing device, a compensation transaction based on the determining of the compensation charge, wherein the second advertisement data is received from a second user device associated with a second user, wherein the processing of the compensation transaction credits the compensation charge to the second user.

11. A system of facilitating dynamic and fractional advertisement scheduling, the system comprising:
a processing device configured for:
obtaining at least one operational period data of at least one presentation device, wherein the at least one operational period data represents at least one operational period of the at least one presentation device;
analyzing the at least one operational period data;
segmenting the at least one operational period into a plurality of time segments based on the analyzing of the at least one operational period data;
analyzing a preference data;
identifying at least one preferred time segment from the plurality of time segments for presenting at least one content based on the analyzing of the preference data;
assigning an advertisement data to the at least one preferred time segment based on the identifying of the at least one preferred time segment;
generating at least one schedule for the at least one presentation device based on the assigning; and
executing the at least one schedule, wherein the executing of the at least one schedule comprises presenting the at least one content during the at least one preferred time segment; and
a communication device communicatively coupled with the processing device, wherein the communication device is configured for:
receiving the advertisement data from a user device associated with a user, wherein the advertisement data comprises the at least one content to be presented on the at least one presentation device; and
receiving the preference data from the user device, wherein the preference data indicates a user preference for the presenting of the at least one content on the at least one presentation device.

12. The system of claim 11, wherein the at least one schedule indicates the at least one schedule of a plurality of advertisement data in the plurality of time segments, wherein the user preference corresponds to prioritizing the advertisement data for the at least one preferred time segment, wherein the assigning of the advertisement data comprises assigning the advertisement data to the at least one preferred time segment by a dynamic allocation of a second advertisement data from the at least one preferred time segment to at least one of the plurality of time segments, wherein the plurality of advertisement data comprises the second advertisement data, wherein the at least one of the plurality of time segments is different from the at least one preferred time segment.

13. The system of claim 11, wherein the processing device is further configured for analyzing the advertisement data using at least one Artificial Intelligence (AI) model, wherein the at least one AI model is configured to check a compliance of the at least one content with at least one of a brand safety guideline and a regulatory guideline, wherein the assigning of the advertisement data to the at least one preferred time segment is further based on the analyzing of the advertisement data.

14. The system of claim 11, wherein the segmenting of the at least one operational period into the plurality of time segments comprises segmenting the at least one operational period into the plurality of time segments using at least one fractional scheduling engine, wherein the at least one fractional scheduling engine is configured to algorithmically segment the at least one operational period into the plurality of time segments.

15. The system of claim 11, wherein the processing device is further configured for determining at least one parameter using at least one fractional scheduling engine based on the analyzing of the preference data, wherein the identifying of the at least one preferred time segment is further based on the determining of the at least one parameter using the at least one fractional scheduling engine, wherein the at least one preferred time segment is characterized by the at least one parameter.

16. The system of claim 13, wherein the processing device is further configured for determining an infringement of at least one of the brand safety guideline and the regulatory guideline by the at least one content based on the analyzing of the advertisement data using the at least one AI model, wherein the communication device is further configured for transmitting the advertisement data to a reviewer device for a human review of the at least one content based on the determining of the infringement, wherein the assigning of the advertisement data is further based on the human review of the at least one content.

17. The system of claim 11, wherein the communication device is further configured for receiving at least one alert data from at least one of at least one external data source and at least one external device, wherein the at least one alert data comprises at least one emergency content to alert at least one person, wherein the processing device is further configured for:
analyzing the at least one alert data; and
performing at least one operation using at least one emergency override module based on the analyzing of the at least one alert data, wherein the at least one emergency override module is configured for interrupting the presenting of the at least one content on the at least one presentation device, wherein the performing of the at least one operation comprises presenting the at least one emergency content on the at least one presentation device, wherein the executing of the at least one schedule is further based on the performing of the at least one operation.

18. The system of claim 11, wherein the communication device is configured for receiving a user indication data from the user device, wherein the user indication data indicates a category of the at least one content, wherein the processing device is further configured for:
analyzing the user indication data;
determining at least one technical functionality associated with the category based on the analyzing of the user indication data; and
enabling the at least one technical functionality to the user based on the determining of the at least one technical functionality, wherein at least one of the receiving of the advertisement data, the receiving of the preference data, and the assigning of the advertisement data is further based on the enabling of the at least one technical functionality.

19. The system of claim 12, wherein the assigning of the advertisement data to the at least one preferred time segment comprises assigning of the advertisement data to the at least one preferred time segment using at least one fractional scheduling engine, wherein the at least one scheduling engine is configured to use a scheduling algorithm for the dynamic allocation.

20. The system of claim 12, wherein the processing device is further configured for:
computing a surcharge for the prioritizing of the at least one content in the at least one schedule using a priority module based on the analyzing of the preference data, wherein the priority module is configured to use at least one formula for the computing of the surcharge, wherein the at least one formula reflects a demand of the at least one operational period;
determining a compensation charge for the prioritizing the at least one content over the second advertisement data for the at least one preferred time segment based on each of the computing of the surcharge and the assigning of the advertisement data; and
processing a compensation transaction based on the determining of the compensation charge, wherein the second advertisement data is received from a second user device associated with a second user, wherein the processing of the compensation transaction credits the compensation charge to the second user.
